(19) United States
(12) Patent Application Publication
(10) Pub. No.: US 2009/0322780 A1
(43) Pub. Date: Dec. 31, 2009

(54) RECORDING DEVICE AND RECORDING CONTROL METHOD, REPRODUCTION DEVICE AND REPRODUCTION CONTROL METHOD, OUTPUT DEVICE AND OUTPUT CONTROL METHOD, AND PROGRAMS

(75) Inventors: Takami MIZUKURA, Kanagawa (JP); Naoya KATOH, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/436,369

(22) Filed: May 6, 2009

(30) Foreign Application Priority Data
Jun. 27, 2008 (JP) 2008-169153

(51) Int. Cl. G09G 5/02

(52) U.S. Cl. 345/590

(57) ABSTRACT

A recording device includes a color gamut conversion control unit, a color gamut conversion unit, and a recording unit. The color gamut conversion control unit controls a method of converting the color gamut of content data, on the basis of a user-specified condition specified by a user. The color gamut conversion unit converts the color gamut of the content data in accordance with the control of the color gamut conversion control unit. The recording unit records, on a recording medium, the content data, the color gamut of which has been converted by the color gamut conversion unit in accordance with the control of the color gamut conversion control unit, or the content data, the color gamut of which has not been converted by the color gamut conversion unit in accordance with the control of the color gamut conversion control unit.

### BACKGROUND OF THE INVENTION

1. Field of the Invention

The present invention relates to a recording device and a recording control method, a reproduction device and a reproduction control method, an output device and an output control method, and programs. The present invention particularly relates to a recording device and a recording control method, a reproduction device and a reproduction control method, an output device and an output control method, and programs capable of performing more reliable and appropriate color gamut compression, even when content data is handled by a plurality of devices.

2. Description of the Related Art

In recent years, various types of digital image devices having different color expression regions have been increasing in number. Particularly in image display devices, the expansion of the color gamut is remarkable. The color gamut has been substantially expanded in the development from CRT (Cathode Ray Tube) display to plasma display, LCD (Liquid Crystal Display), and OELD (Organic Electro Luminescence Display). Further, many imaging devices, such as a digital still camera and a video camera, capable of imaging colors outside an sRGB (standard RGB) color gamut have been appearing. Therefore, a method has been sought which smoothly outputs wide color gamut image data of a captured image to devices having different color gamuts, such as a wide color gamut display, while suppressing color mismatch and hue shift occurring in a high-luminance and high-saturation color.

Major color matching methods for solving the issue of color mismatch between devices include the following three methods, for example.

The first method uses an ICC (International Color Consortium) profile. The ICC profile is a file describing the properties of an image device defined by an organization called ICC. Normally, two profiles including an input device ICC profile and an output device ICC profile are used to output one image file. The input device ICC profile is embedded in the image file in many cases. When the image of the file is output to another device via a PC (Personal Computer), an application on the PC supporting the ICC profile performs appropriate color gamut matching by using the output device ICC profile, to thereby output the image. This method is based on the assumption that image processing and conversion are performed with the use of a PC, or that an output device supports the ICC profile.

Further, there is a method using sRGB space as a system for matching colors without taking account of the difference in color gamut between devices. The sRGB is an international standard of color space formulated by the IEC (International Electrotechnical Commission) in October 1998. The color space was set to ensure color reproducibility between different environments, such as between different PC models and different devices such as a display and a printer, and was formulated on the basis of the color gamut of the CRT display. For example, if a digital camera, a PC, a display, and a printer are all compatible with the sRGB, it is possible to match color appearances without any particular processing, when a captured image is displayed on the display or printed out. As compared with a workflow based on the ICC profile, the use of a PC is unnecessary, and the processing is substantially simple and convenient. However, the sRGB is narrower in expressible color range than other color spaces. Thus, it is difficult in the sRGB to express such colors as emerald green, dark cyan, orange, light red, and yellow. Therefore, the sRGB is unsuitable for professional use wherein photographs and graphic designs are specifically handled.

Further, a movement for color matching using the Exif (Exchangeable image file format) standard is taking place mainly in the digital still camera and printer industries. The Exif is a format standard for recording an image file, and was proposed and formulated by the JEITA (Japan Electronics and Information Technology Industries Association). Most digital camera manufacturers use this format, as well as the DCF (Design rule for Camera File system) which is a file system standard. Specifically, color space can be described as the header information of an image file. By reading the header information, therefore, a printer can perform more appropriate color conversion into the printer color gamut. Particularly, with Exif Ver. 2.21, in addition to the sRGB supported by the previous versions, Adobe RGB, which is wider in color gamut than the sRGB and normally used in such business fields as the printing industry, can also be used as supported color space. Accordingly, it is now possible to express emerald green and dark cyan, which are difficult to express in the sRGB of the related art. A workflow of a printing operation using the Exif standard is called Exif Print. If a printer has a function of reading an Exif header, the Exif Print can be performed. Therefore, the use of a PC is unnecessary, and the printing operation can be performed with a memory card directly inserted in the printer. There is another standard PIM (PRINT Image Matching) similar to the Exif.

However, in a method using the ICC profile, for example, the ICC profile is embedded in an image file. Therefore, the size of the image file may be unnecessarily increased. Further, a PC application or an output device creates a CMM (Color Matching Module) for reading the ICC profile and performing appropriate processing. However, the CMM is created by respective companies, each with an idea unique thereto. Therefore, even if the color matching is guaranteed within a color gamut common to the input device and the output device, not much attention is paid to colors outside the color gamut of the devices. Therefore, in a high- or low-luminance and high-saturation color, which tends to be outside the color gamut, a hue shift often occurs due to natural clip.

The natural clip refers to a phenomenon in which, when a color of eternally supplied image data is outside the color gamut of a device, the color is forcibly expressed by a color within the color gamut of the device. For example, if only the R component of a color represented by RGB has a value greater than the maximum value of the R component of the color gamut, the R component of the color is represented by the maximum value of the R component of the color gamut (natural clip). In this case, the RGB balance of the original color is lost due to the natural clip, and the hue is changed. Such a change in hue is referred to as the hue shift. That is, the original color is expressed by a color different therefrom. Therefore, the occurrence of such hue shift is undesirable.

Further, in the method using the sRGB, for example, the assumed color gamut corresponds to the color gamut of a standard PC CRT monitor, and thus is narrow. A workflow based on the sRGB does not include a process of performing color gamut compression between devices. Thus, the natural clip occurs in a color outside the sRGB color gamut, and the hue shift occurs in a high- or low-luminance and high-saturation color. The use of the sRGB, therefore, may prevent appropriate expression of dark cyan and green colors printable by a common printer and red displayable on an LCD, the color gamut of which has been dramatically expanded in recent years.

Further, in the method using the PIM or the Exif, the output device performs processing in accordance with the image header information defined by the PIM or the Exif. Therefore, the processing load on the output device may be increased. Further, the content of the processing relies on the output device. Therefore, the color reproducibility intended by the input device may not be guaranteed.

Further, all of the methods described above are mainly for processing a still image, and thus are not suitable for color matching of a moving image, wherein the processing is performed in real time.

In view of the above, to realize a practical color reproduction technique not relying on a device, methods for performing appropriate color matching between devices have been proposed (see Japanese Unexamined Patent Application Publication Nos. 09-098298 and 07-236069, for example).

For example, according to the method described in Japanese Unexamined Patent Application Publication No. 09-098298 (corresponding to U.S. Pat. No. 5,933,253), the color reproduction region of an input system is divided into four regions on a two-dimensional plane by the use of two straight lines, and color gamut compression is performed with the compression direction changed for each of the regions.

Further, according to the method described in Japanese Unexamined Patent Application Publication No. 07-236069, for example, only the chromaticity coordinates of eight points indicating representative colors of red (R), green (G), blue (B), cyan (C), magenta (M), yellow (Y), black (K), and white (W) are exchanged. The conversion of intermediate colors between the above-listed colors is performed in accordance with the conversion results of the eight representative colors.

In addition to the above-described methods, a variety of other methods have been proposed as the algorithm for the color gamut conversion as described above.

### SUMMARY OF THE INVENTION

However, there is no color gamut optimal for all devices. For example, a color gamut may be too narrow for the display capability of a device. Further, the data amount may be too large for the data transmission capability of a device, and the processing may be complicated for the processing capability of a device.

Therefore, particularly in a system in which one content data item is shared by an arbitrary plurality of devices, e.g., a system in which mutually different devices perform such operations as imaging, recording, reproduction, and display (output), the color gamut is controlled in accordance with the devices constituting the system. In general, an imaging device has a wide color gamut, while a display device has a narrow color gamut. Therefore, it is desirable to compress the color gamut of image data during a process from the imaging (generation of image data) to the display (output of an image).

If the color gamut of content data is too narrow for the capability of a device, the expression capability of image data may be unnecessarily reduced. Meanwhile, if the color gamut of content data is too wide for the capability of a device, a device failure may be caused.

Therefore, it is desired to perform reliable and appropriate color gamut control in any combination of devices. As described above, however, the appropriate color gamut is different from device to device. Therefore, it is desirable to determine the color gamut control method (color gamut compression method) in accordance with the respective configurations of the devices. However, there has not been a system satisfying such a demand.

The present invention has been proposed in view of the above circumstances. It is desirable to enable more reliable and appropriate compression of the color gamut of content data, even when the content data is handled by a plurality of devices.

A recording device according to an embodiment of the present invention includes color gamut conversion control means, color gamut conversion means, and recording means. The color gamut conversion control means controls a method of converting the color gamut of content data, on the basis of a user-specified condition specified by a user. The color gamut conversion means converts the color gamut of the content data in accordance with the control of the color gamut conversion control means. The recording means records, on a recording medium, the content data, the color gamut of which has been converted by the color gamut conversion means in accordance with the control of the color gamut conversion control means, or the content data, the color gamut of which has not been converted by the color gamut conversion means in accordance with the control of the color gamut conversion control means.

The color gamut conversion control means may perform the control such that the color gamut of the content data is converted into a color gamut specified by the user.

The color gamut conversion control means may perform the control such that the color gamut of the content data is converted into a color gamut corresponding to a file format specified by the user.

A recording control method according to an embodiment of the present invention includes the steps of: determining a method of converting the color gamut of content data, on the basis of a user-specified condition specified by a user; converting the color gamut of the content data in accordance with the determined method of converting the color gamut; and controlling the recording, on a recording medium, of the content data, the color gamut of which has been converted, or the content data, the color gamut of which has not been converted.

A program according to an embodiment of the present invention causes a computer to perform a recording control method. The recording control method includes the steps of: determining a method of converting the color gamut of content data, on the basis of a user-specified condition specified by a user; converting the color gamut of the content data in accordance with the determined method of converting the color gamut; and controlling the recording, on a recording medium, of the content data, the color gamut of which has been converted, or the content data, the color gamut of which has not been converted.

A reproduction device according to another embodiment of the present invention includes reading means, conversion state checking means, color gamut conversion control means, and color gamut conversion means. The reading means reads content data recorded on a recording medium. The conversion state checking means checks the conversion state of the color gamut of the content data read by the reading means. If it is confirmed by the conversion state checking means that the color gamut of the content data has not been converted into the color gamut of an output device at a subsequent stage, the color gamut conversion control means controls a method of converting the color gamut of the content data, on the basis of information relating to the output device. The color gamut conversion means converts the color gamut of the content data in accordance with the control of the color gamut conversion control means.

The color gamut conversion control means may control the method of converting the color gamut of the content data, in accordance with whether or not the manufacturer of the output device matches the manufacturer of the reproduction device.

The color gamut conversion control means may control the method of converting the color gamut of the content data, in accordance with whether or not a color gamut conversion algorithm version of the output device is superior to a color gamut conversion algorithm version of the reproduction device.

A reproduction control method according to another embodiment of the present invention includes the steps of: controlling the reading of content data recorded on a recording medium; checking the conversion state of the color gamut of the read content data; determining, if it is confirmed that the color gamut of the content data has not been converted into the color gamut of an output device at a subsequent stage, a method of converting the color gamut of the content data, on the basis of information relating to the output device; and converting the color gamut of the content data in accordance with the determined method of converting the color gamut.

A program according to another embodiment of the present invention causes a computer to perform a reproduction control method. The reproduction control method includes the steps of: controlling the reading of content data recorded on a recording medium; checking the conversion state of the color gamut of the read content data; determining, if it is confirmed that the color gamut of the content data has not been converted into the color gamut of an output device at a subsequent stage, a method of converting the color gamut of the content data, on the basis of information relating to the output device; and converting the color gamut of the content data in accordance with the determined method of converting the color gamut.

An output device according to still another embodiment of the present invention includes conversion state checking means, color gamut conversion control means, color gamut conversion means, and output means. The conversion state checking means checks the conversion state of the color gamut of content data. If it is confirmed by the conversion state checking means that the color gamut of the content data has not been converted into the color gamut of the output device, the color gamut conversion control means controls a method of converting the color gamut of the content data, on the basis of information relating to a reproduction device at a previous stage. The color gamut conversion means converts the color gamut of the content data into the color gamut of the output device in accordance with the control of the color gamut conversion control means. The output means outputs the content data having the color gamut of the output device.

An output control method according to still another embodiment of the present invention includes the steps of: checking the conversion state of the color gamut of content data; determining, if it is confirmed that the color gamut of the content data has not been converted into the color gamut of an output device, a method of converting the color gamut of the content data, on the basis of information relating to a reproduction device at a previous stage; converting the color gamut of the content data into the color gamut of the output device in accordance with the determined method of converting the color gamut; and controlling the output of the content data having the color gamut of the output device.

A program according to still another embodiment of the present invention causes a computer to perform an output control method. The output control method includes the steps of: checking the conversion state of the color gamut of content data; determining, if it is confirmed that the color gamut of the content data has not been converted into the color gamut of an output device, a method of converting the color gamut of the content data, on the basis of information relating to a reproduction device at a previous stage; converting the color gamut of the content data into the color gamut of the output device in accordance with the determined method of converting the color gamut; and controlling the output of the content data having the color gamut of the output device.

In an embodiment of the present invention, a method of converting the color gamut of content data is controlled on the basis of a user-specified condition specified by a user, and the color gamut of the content data is converted. Then, the content data, the color gamut of which has been converted, or the content data, the color gamut of which has not been converted, is recorded on a recording medium.

In another embodiment of the present invention, content data recorded on a recording medium is read, and the conversion state of the color gamut of the read content data is checked. If it is confirmed that the color gamut of the content data has not been converted into the color gamut of an output device at a subsequent stage, a method of converting the color gamut of the content data is controlled on the basis of information relating to the output device, and the color gamut of the content data is converted.

In still another embodiment of the present invention, the conversion state of the color gamut of content data is checked. If it is confirmed that the color gamut of the content data has not been converted into the color gamut of an output device, a method of converting the color gamut of the content data is controlled on the basis of information relating to a reproduction device at a previous stage. Then, the color gamut of the content data is converted into the color gamut of the output device, and the content data having the color gamut of the output device is output.

According to the embodiments of the present invention, the color gamut of content data can be compressed. Particularly, even when content data is handled by a plurality of device, more reliable and appropriate compression of the color gamut of the content data can be performed.

### BRIEF DESCRIPTION OF THE DRAWINGS

FIG. 1 is a block diagram illustrating a configuration example of an information processing system to which an embodiment of the present invention is applied;

FIG. 2 is a schematic diagram illustrating a detailed configuration example of a recording device;

FIG. 3 is a schematic diagram illustrating a detailed configuration example of a reproduction device;

FIG. 4 is a schematic diagram illustrating a detailed configuration example of an output device;

FIG. 5 is a flowchart for explaining an example of the flow of recording control processing;

FIG. 6 is a flowchart for explaining another example of the flow of recording control processing;

FIG. 7 is a flowchart for explaining an example of the flow of reproduction determination processing;

FIG. 8 is a flowchart for explaining an example of the flow of reproduction control processing;

FIG. 9 is a flowchart for explaining an example of the flow of output control processing;

FIG. 10 is a flowchart for explaining another example of the flow of reproduction control processing;

FIG. 11 is a flowchart for explaining another example of the flow of output control processing;

FIG. 12 is a flowchart for explaining still another example of the flow of reproduction control processing;

FIG. 13 is a flowchart for explaining still another example of the flow of output control processing;

FIG. 14 is a schematic diagram illustrating another configuration example of the reproduction device;

FIG. 15 is a schematic diagram illustrating another configuration example of the output device;

FIG. 16 is a flowchart for explaining still another example of the flow of output control processing;

FIG. 17 is a flowchart for explaining still another example of the flow of reproduction control processing;

FIG. 18 is a flowchart for explaining still another example of the flow of output control processing;

FIG. 19 is a flowchart for explaining still another example of the flow of reproduction control processing;

FIG. 20 is a block diagram illustrating a more specific example of an information processing system to which an embodiment of the present invention is applied;

FIGS. 21A and 21B are schematic diagrams illustrating an example of xy chromaticity information of DCI-P3;

FIGS. 22A to 22E are schematic diagrams illustrating an example of a Cusp table;

FIGS. 23A and 23B are schematic diagrams illustrating an example of xy chromaticity information of BT709;

FIGS. 24A to 24E are schematic diagrams illustrating an example of a Cusp table; and

FIG. 25 is a block diagram illustrating a configuration example of a personal computer to which an embodiment of the present invention is applied.

### DESCRIPTION OF THE PREFERRED EMBODIMENTS

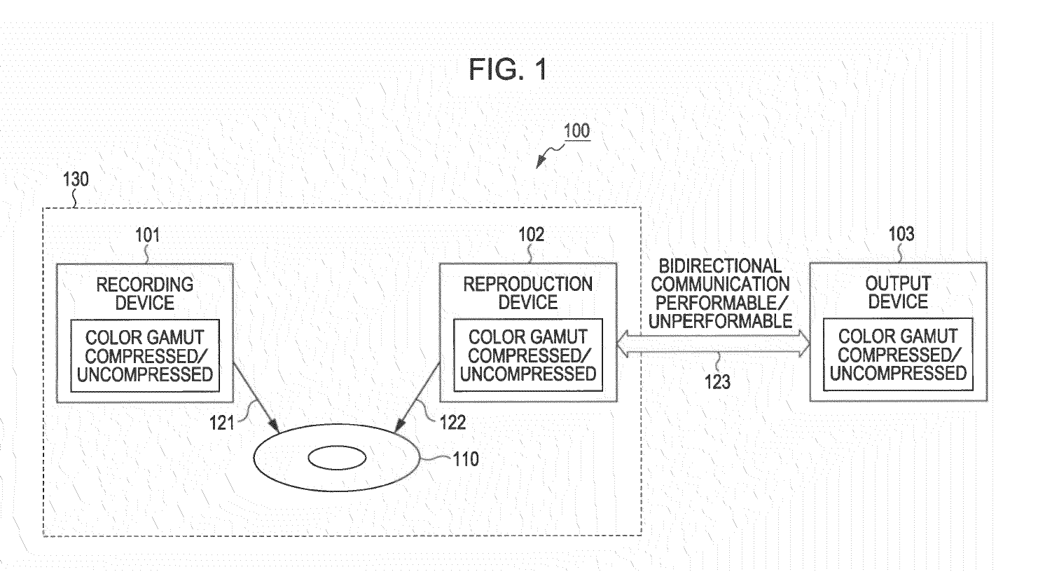

FIG. 1 is a block diagram illustrating a configuration example of major components of an information processing system to which an embodiment of the present invention is applied.

An information processing system 100 illustrated in FIG. 1 performs a variety of processing relating to content data (image data), such as the generation of the image data through an imaging operation (or the acquisition of the image data from outside the system), the recording on a recording medium of the image data as the content data, the reading (reproduction) of the image data from the recording medium, and the display (output) of the image of the reproduced image data. Further, along with the above processing, the information processing system 100 performs more reliable and appropriate compression of the color gamut of the image data as the content data.

For convenience of explanation, the following description will be made of an example in which the color gamut is compressed. Although the color gamut can also be expanded, of course, by a similar method, description thereof will be omitted. That is, the processing relating to the color gamut compression described below can be understood to relate to “color gamut conversion” including both color gamut compression and color gamut expansion.

The information processing system 100 includes a recording device 101, a reproduction device 102, and an output device 103.

The recording device 101 records, on an optical disk 110 serving as a recording medium, the image data obtained through the imaging operation or acquired from outside the system. In this process, the recording device 101 controls, for example, whether or not the color gamut of the image data should be compressed, and if so, how the compression should be performed.

The reproduction device 102 reads the image data recorded on the optical disk 110, and supplies the image data to the output device 103 via a bus 123. In this process, the reproduction device 102 controls, for example, whether or not the color gamut of the image data should be compressed, and if so, which one of the reproduction device 102 and the output device 103 should perform the compression.

The output device 103 displays the image of the image data supplied by the reproduction device 102 via the bus 123. In this process, in accordance with the control of the reproduction device 102, the output device 103 controls, for example, whether or not the color gamut compression should be performed.

The optical disk 110 is a writable (recordable or rewritable) recording medium. Examples of the optical disk 110 include a CD-R (Compact Disc-Recordable), a CD-RW (Compact Disc-Rewritable), a DVD±R (Digital Versatile Disc±Recordable), a DVD±RW (Digital Versatile Disc±Rewritable), a DVD±RAM (Digital Versatile Disc-Random Access Memory), a BD-R (Blu-ray Disc-Recordable), and a BD-RE (Blu-ray Disc-Rewritable), for instance. Optical disks (recording media) other than the ones according to the above standards can also be used, of course, if compatible with the recording device 101 and the reproduction device 102.

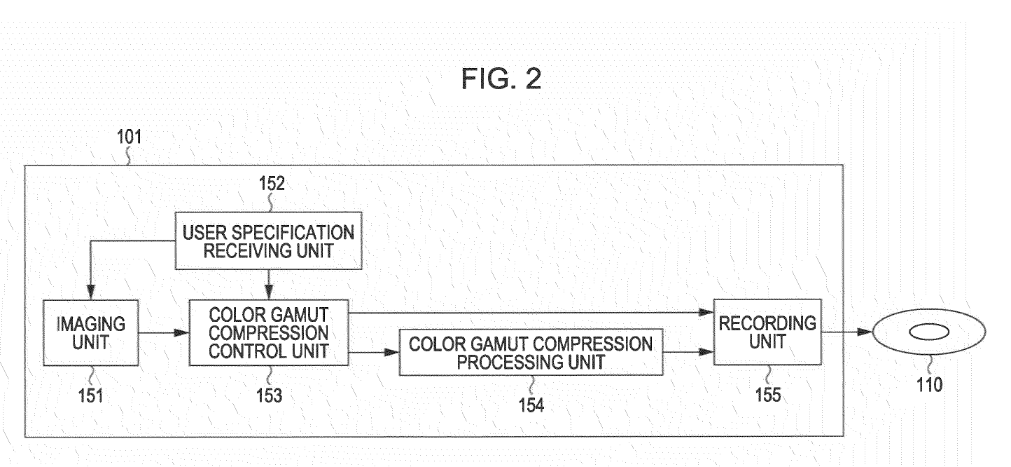

FIG. 2 is a block diagram illustrating a detailed configuration example of the recording device 101. As illustrated in FIG. 2, the recording device 101 includes an imaging unit 151, a user specification receiving unit 152, a color gamut compression control unit 153, a color gamut compression processing unit 154, and a recording unit 155. The imaging unit 151 captures an image of a subject on the basis of a user specification received by the user specification receiving unit 152, generates the image data of the image, and supplies the image data to the color gamut compression control unit 153.

The color gamut compression control unit 153 selects the most suitable color gamut compression method on the basis of the user specification. On the basis of the control of the color gamut compression control unit 153 (in accordance with the selected method), the color gamut compression processing unit 154 compresses the color gamut of the image data, and generates color gamut metadata representing the compressed color gamut. An arrow directed from the color gamut compression control unit 153 to the recording unit 155 indicates a processing flow in a configuration example in which the recording device 101 does not include the color gamut compression processing unit 154.

The recording unit 155 records, on the optical disk 110, the image data (and the color gamut metadata thereof, if the color gamut metadata has been generated) supplied by the color gamut compression processing unit 154 or the image data supplied by the color gamut compression control unit 153, as the content data.

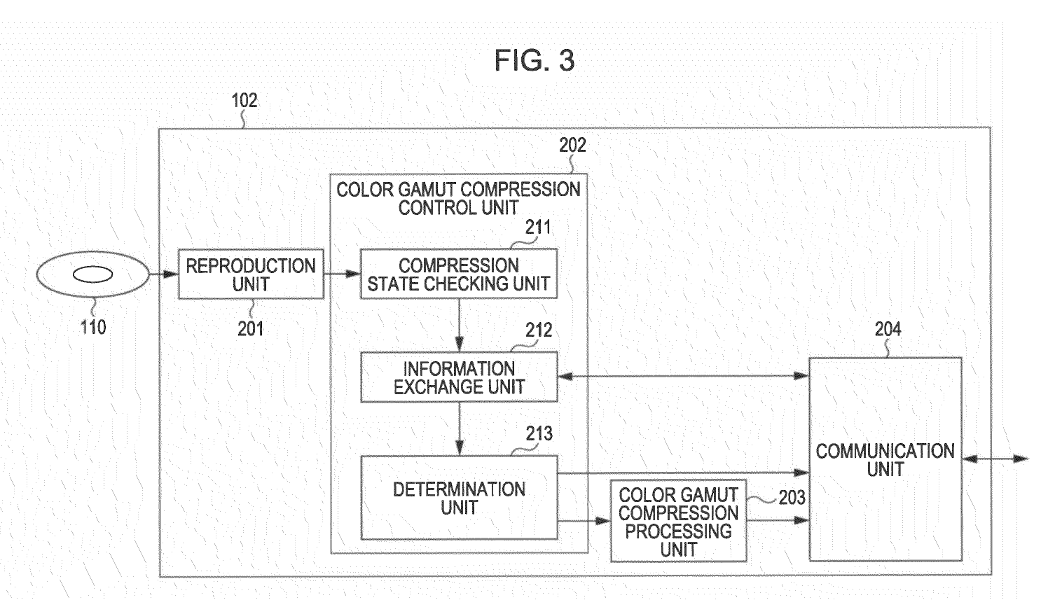

FIG. 3 is a block diagram illustrating a detailed configuration example of the reproduction device 102. As illustrated in FIG. 3, the reproduction device 102 includes a reproduction unit 201, a color gamut compression control unit 202, a color gamut compression processing unit 203, and a communication unit 204. The reproduction unit 201 reads the content data (the image data, and the color gamut metadata if attached to the image data) recorded on the optical disk 110, and supplies the content data to a compression state checking unit 211 of the color gamut compression control unit 202.

The color gamut compression control unit 202 controls processing relating to color gamut compression of the image data (and the color gamut metadata) read by the reproduction unit 201. For example, the color gamut compression control unit 202 selects, for example, whether or not further color gamut compression should be performed on the read image data, and if so, which one of the reproduction device 102 and the output device 103 at a subsequent stage should perform the color gamut compression. The color gamut compression control unit 202 includes the compression state checking unit 211, an information exchange unit 212, and a determination unit 213. With reference to the color gamut of the image data read from the optical disk 100, the compression state checking unit 211 checks the color gamut compression state, such as whether or not the color gamut has already been compressed. The information exchange unit 212 communicates with the output device 103 via the communication unit 204 to exchange information relating to the color gamut compression. The determination unit 213 makes a determination on the color gamut compression on the basis of the information acquired from the compression state checking unit 211 and the information exchange unit 212.

The color gamut compression processing unit 203 performs the color gamut compression in accordance with the control of the color gamut compression control unit 202. An arrow directed from the determination unit 213 of the color gamut compression control unit 202 to the communication unit 204 indicates a processing flow in a configuration example in which the reproduction device 102 does not include the color gamut compression processing unit 203.

The communication unit 204 communicates with the output device 103 to exchange the information relating to the color gamut compression and supply the image data (and the color gamut metadata) to the output device 103.

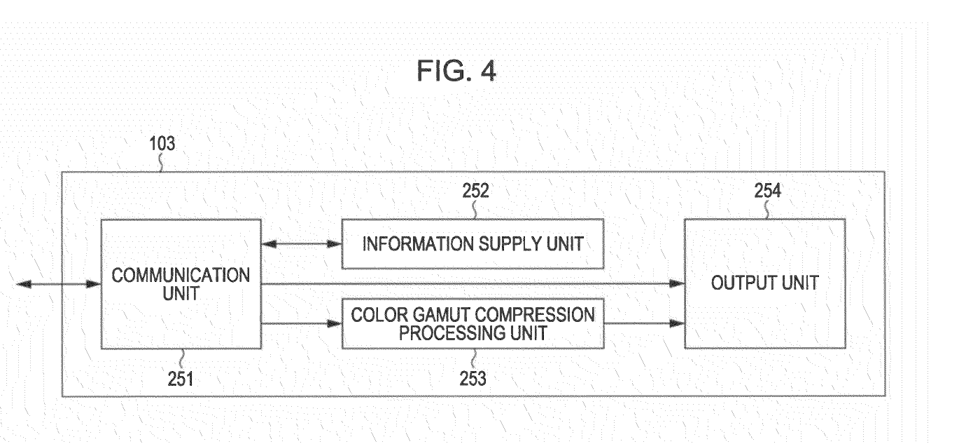

FIG. 4 is a block diagram illustrating a detailed configuration example of the output device 103. As illustrated in FIG. 4, the output device 103 includes a communication unit 251, an information supply unit 252, a color gamut compression processing unit 253, and an output unit 254. The communication unit 251 communicates with the reproduction device 102 to exchange the information relating to the color gamut compression and acquire the image data (and the color gamut metadata) from the reproduction device 102.

The information supply unit 252 supplies the information relating to the color gamut compression to the reproduction device 102 via the communication unit 251. The color gamut compression processing unit 253 compresses the color gamut of the image data supplied via the communication unit 251. An arrow directed from the communication unit 251 to the output unit 254 indicates a processing flow in a configuration example in which the output device 103 does not include the color gamut compression processing unit 253.

The output unit 254 is formed by an LCD, a plasma display, or the like, and displays (outputs) the image of the image data.

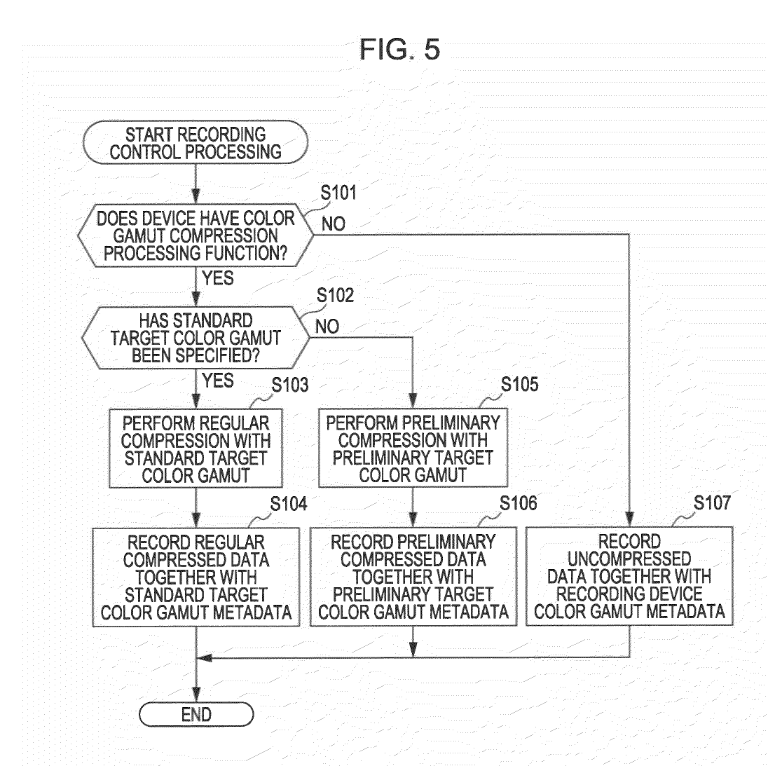

In the recording of the image data on the optical disk 110, the color gamut compression control unit 153 of the recording device 101 controls the compression of the color gamut of the image data. With reference to the flowchart of FIG. 5, an example of the flow of recording control processing will be described.

Upon start of the recording control processing, the color gamut compression control unit 153 at Step S101 determines whether or not the recording device 101 has a color gamut compression processing function, i.e., the color gamut compression processing unit 154. If it is determined that the recording device 101 has the color gamut compression processing function, the color gamut compression control unit 153 proceeds the processing to Step S102. At Step S102, the color gamut compression control unit 153 determines whether or not a standard target color gamut of the information processing system 100 has been specified in the user specification received by the user specification receiving unit 152. The standard target color gamut refers to a color gamut previously set as the standard value of a target color gamut which is the final color gamut of the image data. The color gamut compression control unit 153 determines whether or not the standard target color gamut has been specified by a user as the color gamut to be obtained after the compression. If it is determined that the standard target color gamut has been specified, the color gamut compression control unit 153 proceeds the processing to Step S103, and controls the color gamut compression processing unit 154 to perform regular compression with the standard target color gamut.

The regular compression refers to the compression of the color gamut of the image data into the color gamut used in the output of the image, i.e., the final color gamut. For example, the color gamut of the image in the imaging operation is sufficiently wide and substantially infinite. However, it is difficult to directly use the color gamut in the reproduction device 102 and the output device 103. Therefore, the color gamut of the image data is compressed. Herein, the compression into the color gamut used in the output of the image by the output device 103 is referred to as the regular compression. Normally, the target color gamut in the regular compression is the standard target color gamut. Further, unnecessary reduction of the color gamut is meaningless. Therefore, the target color gamut in the regular compression is generally the narrowest color gamut. That is, the narrowest one of the color gamuts used in the information processing system 100 is the standard target color gamut.

At Step S104, the color gamut compression control unit 153 controls the recording unit 155 to record, on the optical disk 110, regular compressed data obtained by the regular compression together with the color gamut metadata of the data (standard target color gamut metadata). Then, the recording control processing is ended.

Meanwhile, if it is determined at Step S102 that the standard target color gamut has not been specified, the color gamut compression control unit 153 proceeds the processing to Step S105 to perform preliminary compression with a preliminary target color gamut specified by the user specification received by the user specification receiving unit 152.

The preliminary compression refers to compression other than the regular compression. In the preliminary compression, the target color gamut is normally set to be wider than the target color gamut in the regular compression. For example, the recording device 101 of FIG. 1 records the image data on the optical disk 110 irrespective of the presence or absence of the output device 103. That is, at this stage, the recording device 101 does not know the type of color gamut of the output device 103, and thus is unable to determine the target color gamut. Therefore, the recording device 101 is prevented from performing the regular compression. However, the original color gamut of the image data in the imaging operation is too wide for the reproduction device 102 and the output device 103. For the sake of safety (to prevent a trouble at a subsequent stage), therefore, it is desirable to compress the color gamut of the image data into some sort of target color gamut. Therefore, the color gamut compression control unit 153 sets the preliminary target color gamut on the basis of the user specification, to thereby compress the color gamut of the image data. Such compression is referred to as the preliminary compression.

Upon completion of the preliminary compression, the color gamut compression control unit 153 at Step S106 controls the recording unit 155 to record, on the optical disk 110, the preliminary compressed data obtained by the preliminary compression together with the color gamut metadata of the data (preliminary target color gamut metadata). Then, the recording control processing is ended.

If it is determined at Step S101 that the recording device 101 does not have the color gamut compression processing function (i.e., the color gamut compression processing unit 154), the color gamut compression is prevented. Therefore, the color gamut compression control unit 153 proceeds the processing to Step S107, and controls the recording unit 155 to record, on the optical disk 110, uncompressed data, the color gamut of which has not been compressed, together with recording device color gamut metadata representing the color gamut of the recording device 101. Then, the recording control processing is ended.

As described above, the color gamut compression control unit 153 can determine the target color gamut specified by the user and control the color gamut compression processing unit 154 to compress the image data into the specified color gamut. If the color gamut compression and the target color gamut are the regular compression and the standard target color gamut, respectively, and if all of the devices in the information processing system 100 already know the standard target color gamut, the recording unit 155 at Step S104 can record only the regular compressed data on the optical disk 110.

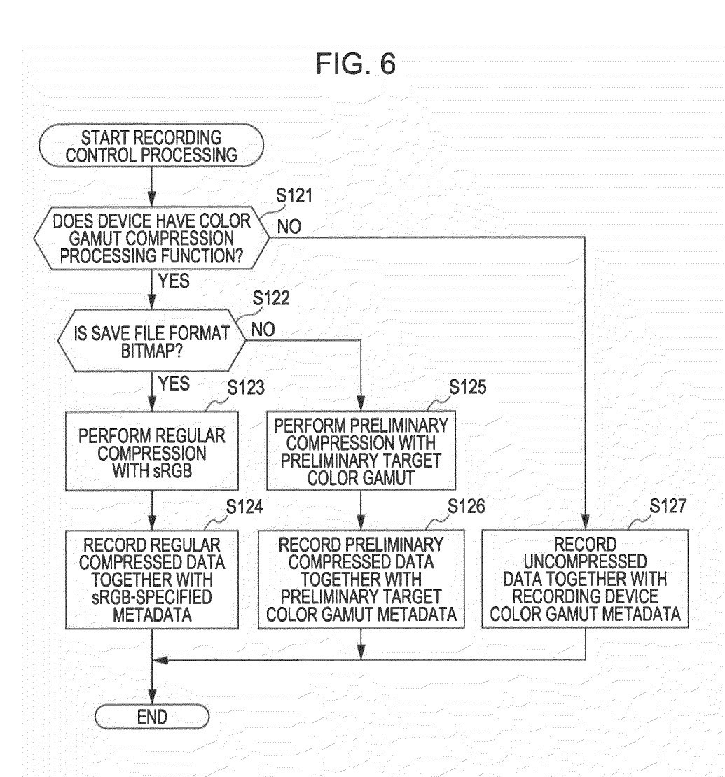

In the above description of the flowchart of FIG. 5, the selection between the regular compression and the preliminary compression is made on the basis of the target color gamut specified by the user. Alternatively, the color gamut compression control unit 153 may make the selection on the basis of a condition other than the above. For example, the color gamut compression control unit 153 may make the selection on the basis of the save file format of the image data specified by the user, as illustrated in the flowchart of FIG. 6.

The flowchart of FIG. 6, which corresponds to the flowchart of FIG. 5, illustrates an example of the flow of recording control processing. At Step S122 in FIG. 6, the color gamut compression control unit 153 determines whether or not the save file format specified by the user specification received by the user specification receiving unit 152 is bitmap.

If the save file format is bitmap, the data is constituted by RGB. Therefore, the color gamut is basically limited to sRGB (standard RGB). The sRGB is an international standard of color space formulated by the IEC (International Electrotechnical Commission) in October 1998. The color space was set to ensure color reproducibility between different environments, such as between different PC models and different devices such as a display and a printer, and was formulated on the basis of the color gamut of the CRT display. For example, if a digital camera, a PC, a display, and a printer are all compatible with the sRGB, it is possible to match color appearances without any particular processing, when a captured image is displayed on the display or printed out. As compared with a workflow based on the ICC profile, the use of a PC is unnecessary, and the processing is substantially simple and convenient. However, the sRGB is narrower in expressible color range than other color spaces. Thus, it is difficult in the sRGB to express such colors as emerald green, dark cyan, orange, light red, and yellow. Therefore, the sRGB is unsuitable for professional use wherein photographs and graphic designs are specifically handled.

Further, in the bitmap format, the header information or the like is absent. Thus, the identity of image data is unknown in many cases, and the type of color gamut of the image data is not guaranteed (unknown). For the sake of safety, therefore, it is desirable to compress the color gamut in any case to prevent a device failure and so forth.

Therefore, if bitmap is specified by the user as the save file format, the color gamut compression control unit 153 proceeds the processing to Step S123, and controls the color gamut compression processing unit 154 to perform the regular compression with the sRGB. Then, at Step S124, the color gamut compression control unit 153 controls the recording unit 155 to record, on the optical disk 110, the regular compressed data together with sRGB-specified metadata.

The other processes are similar to the processes in FIG. 5, and thus description thereof will be omitted.

As described above, if the recording device 101 has the color gamut compression function, the recording device 101 performs the regular compression or the preliminary compression on the color gamut of the image data on the basis of the target color gamut or the save file format specified by the user, i.e., the user-specified condition. In this case, the recording device 101 records, on the optical disk 110, the color gamut metadata together with the image data.

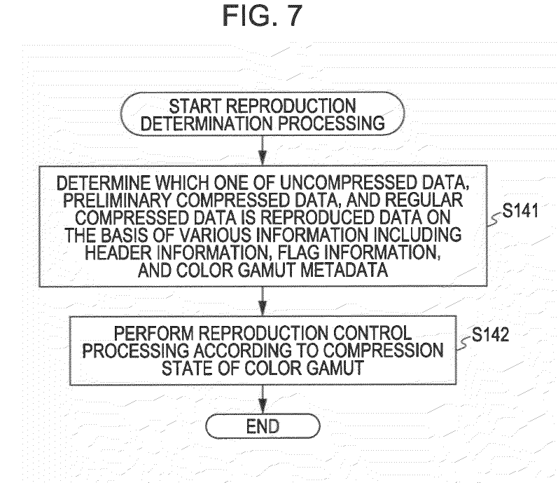

The compression state checking unit 211 checks the compression state of the image data (and the color gamut metadata) read from the optical disk 110 by the reproduction unit 201 of the reproduction device 102. The determination unit 213 performs reproduction determination processing, as illustrated in the flowchart of FIG. 7, to make a determination on the basis of the check result.

That is, on the basis of a variety of information such as the header information, the flag information, and the color gamut metadata of the read image data (reproduced data), the determination unit 213 at Step S141 determines which one of the uncompressed data, the preliminary compressed data, and the regular compressed data is the reproduced data. Then, at Step S142, reproduction control processing according to the compression state of the color gamut is performed, and the reproduction determination processing is ended.

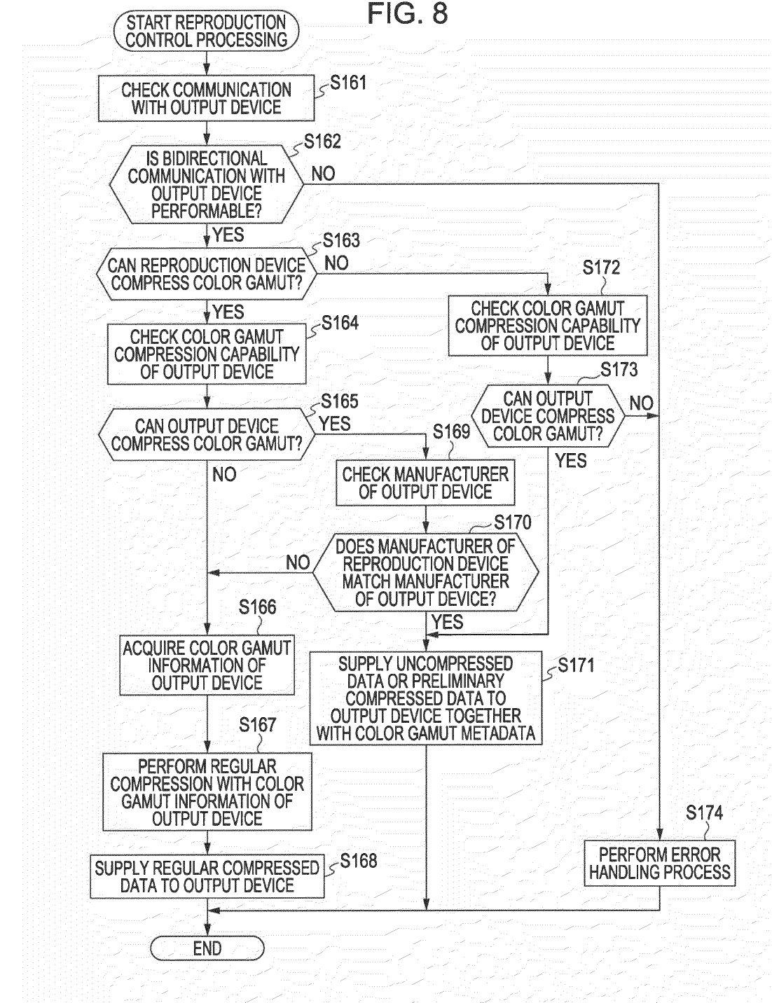

With reference to the flowchart of FIG. 8, description will be first made of an example of the flow of reproduction control processing performed when the reproduced data is determined to be the uncompressed data or the preliminary compressed data, i.e., when at least one more color gamut compression process should be performed before the output of the data.

At Step S161, the information exchange unit 212 checks the communication with the output device 103, and determines at Step S162 whether or not bidirectional communication with the output device 103 is performable. If the bidirectional communication is performable, the determination unit 213 at Step S163 determines whether or not the reproduction device 102 is capable of performing the color gamut compression, i.e., whether or not the reproduction device 102 includes the color gamut compression processing unit 203. If the reproduction device 102 is capable of performing the color gamut compression, the information exchange unit 212 at Step S164 contacts the output device 103 to check the color gamut compression capability of the output device 103. Then, at Step S165, the information exchange unit 212 determines whether or not the output device 103 is capable of performing the color gamut compression.

If the output device 103 is not capable of performing the color gamut compression, the information exchange unit 212 accesses the output device 103 to acquire the color gamut information of the output device 103. At Step S167, the color gamut compression processing unit 203 is controlled by the color gamut compression control unit 202 to perform the regular compression by using the color gamut information of the output device 103. At Step S168, the communication unit 204 is controlled by the color gamut compression control unit 202 to supply the output device 103 with the regular compressed data obtained by the process of Step S167. In this process, the communication unit 204 supplies, as appropriate, the standard target color gamut to the output device 103, together with the regular compressed data.

Meanwhile, if it is determined at Step S165 that the output device 103 is capable of performing the color gamut compression, the processing proceeds to Step S169.

At Step S169, the information exchange unit 212 exchanges information with the output device 103 to check the manufacturer of the output device 103. Then, at Step S170, the information exchange unit 212 determines whether or not the manufacturer of the reproduction device 102 matches the manufacturer of the output device 103. If the manufacturers match, the reproduction device 102 already knows the color gamut of the output device 103. Further, respective compression algorithms or the like of the two devices are mutually compatible in many cases. If the manufacturer of the output device 103 matches the manufacturer of the reproduction device 102, therefore, direct transfer of the uncompressed data or the preliminary compressed data to the output device 103 is relatively safe.

Therefore, the communication unit 204 at Step S171 is controlled by the color gamut compression control unit 202 to supply the uncompressed data or the preliminary compressed data to the output device 103, together with the color gamut metadata. Meanwhile, if the manufacturer of the reproduction device 102 and the manufacturer of the output device 103 do not match, direct transfer of the image data to the output device 103 is unsafe. To perform the regular compression in the reproduction device 102, therefore, the processing is returned to Step S166, and the processes at the step and the subsequent steps are repeated. That is, the regular compressed data is supplied to the output device 103.

Further, if it is determined at Step S163 that the reproduction device 102 is not capable of performing the color gamut compression, the determination unit 213 proceeds the processing to Step S172. At Step S172, the information exchange unit 212 checks the color gamut compression capability of the output device 103. Then, on the basis of the check result, the determination unit 213 at Step S173 determines whether or not the output device 103 is capable of performing the color gamut compression. If the output device 103 is capable of performing the color gamut compression, the processing is returned to Step S171 to have the output device 103 perform the regular compression. If the output device 103 is neither capable of performing the color gamut compression, the processing proceeds to Step S174.

Further, if it is determined at Step S162 that the bidirectional communication with the output device 103 is unperformable, the determination unit 213 proceeds the processing to Step S174. At Step S174, the color gamut compression control unit 202 causes the respective units to perform an error handling process, and the reproduction control processing is ended. That is, in this case, the output of the image data is cancelled due to the inability of both the reproduction device 102 and the output device 103 to perform the color gamut compression or the inability of the reproduction device 102 and the output device 103 to perform the bidirectional communication therebetween (to exchange the information used in the color gamut compression).

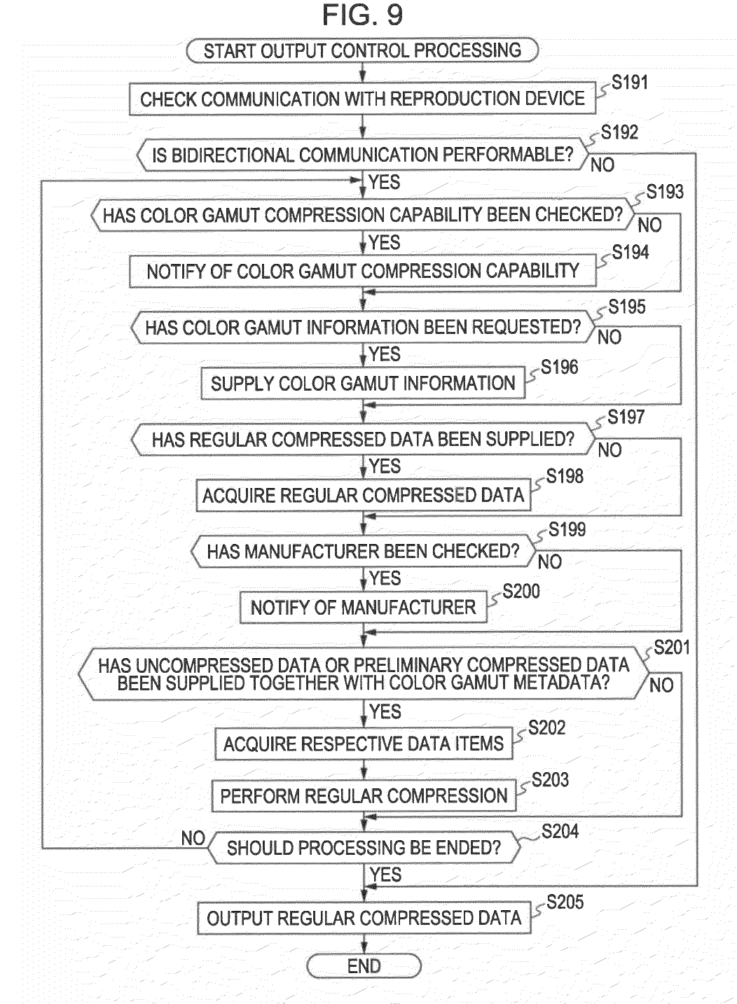

As described above, the reproduction device 102 controls the color gamut compression performed by the reproduction device 102 and the output device 103, on the basis of the availability or unavailability of the bidirectional communication, the presence or absence of the color gamut compression capability, the manufacturer of the devices, and so forth. In this case, the reproduction device 102 takes the initiative in performing the control. In accordance with the control, therefore, the output device 103 performs output control processing, as illustrated in the flowchart of FIG. 9, to respond to a request from the reproduction device 102.

That is, the communication unit 251 at Step S191 checks the communication with the reproduction device 102, and determines at Step S192 whether or not bidirectional communication is performable. If it is determined that the bidirectional communication is performable, the communication unit 251 proceeds the processing to Step S193.

At Step S193, the information supply unit 252 determines whether or not the color gamut compression capability has been checked by the reproduction device 102. If it is determined via the communication unit 251 that the color gamut compression capability has been checked, the information supply unit 252 at Step S194 notifies, via the communication unit 251, the reproduction device 102 of the color gamut compression capability. Meanwhile, if it is determined at Step S193 that the color gamut compression capability has not been checked, the information supply unit 252 omits the process of Step S194.

At Step S195, the information supply unit 252 determines whether or not the color gamut information of the output device 103 has been requested by the reproduction device 102. If it is determined that the color gamut information has been requested, the information supply unit 252 at Step S196 supplies, via the communication unit 251, the reproduction device 102 with the color gamut information representing the color gamut of the output device 103. Meanwhile, if it is determined at Step S195 that the color gamut information has not been requested, the information supply unit 252 omits the process of Step S196.

At Step S197, the communication unit 251 determines whether or not the regular compressed data has been supplied by the reproduction device 102. If it is determined that the regular compressed data has been supplied, the communication unit 251 at Step S198 acquires and supplies the regular compressed data to the output unit 254. Meanwhile, if it is determined at Step S197 that the regular compressed data has been supplied, the communication unit 251 omits the process of Step S198.

At Step S199, the information supply unit 252 determines whether or not the manufacturer has been checked by the reproduction device 102. If it is determined via the communication unit 251 that the manufacturer has been checked, the information supply unit 252 at Step S200 notifies, via the communication unit 251, the reproduction device 102 of the manufacturer (maker). Meanwhile, if it is determined at Step S199 that the manufacturer has not been checked, the information supply unit 252 omits the process of Step S200.

At Step S201, the communication unit 251 determines whether or not the uncompressed data or the preliminary compressed data has been supplied by the reproduction device 102 together with the color gamut metadata of the data. If it is determined that the uncompressed data or the preliminary compressed data has been supplied, the communication unit 251 at Step S202 acquires the respective data items. Then, at Step S203, the regular compression of the image data is performed with the color gamut information of the output device 103, and the regular compressed data is supplied to the output unit 254. Meanwhile, if it is determined at Step S201 that the uncompressed data or the preliminary compressed data has not been supplied, the communication unit 251 omits the processes of Steps S202 and S203.

At Step S204, the information supply unit 252 determines whether or not the output control processing should be ended. If it is determined that the output control processing should not be ended, the processing is returned to Step S193 to repeat the processes at the step and the subsequent steps. Meanwhile, if is determined at Step S204 that the output control processing should be ended, the processing proceeds to Step S205. At Step S205, the output unit 254 outputs the regular compressed data (or the image thereof), and the output control processing is ended. Further, if it is determined at Step S192 that the bidirectional communication is unperformable, the information supply unit 252 proceeds the processing to Step S205 to output the regular compressed data, and the output control processing is ended.

As described above, with the control performed in accordance with the variety of conditions, the reproduction device 102 and the output device 103 can perform more reliable and appropriate compression of the color gamut of content data, even when the content data is handled by a plurality of devices.

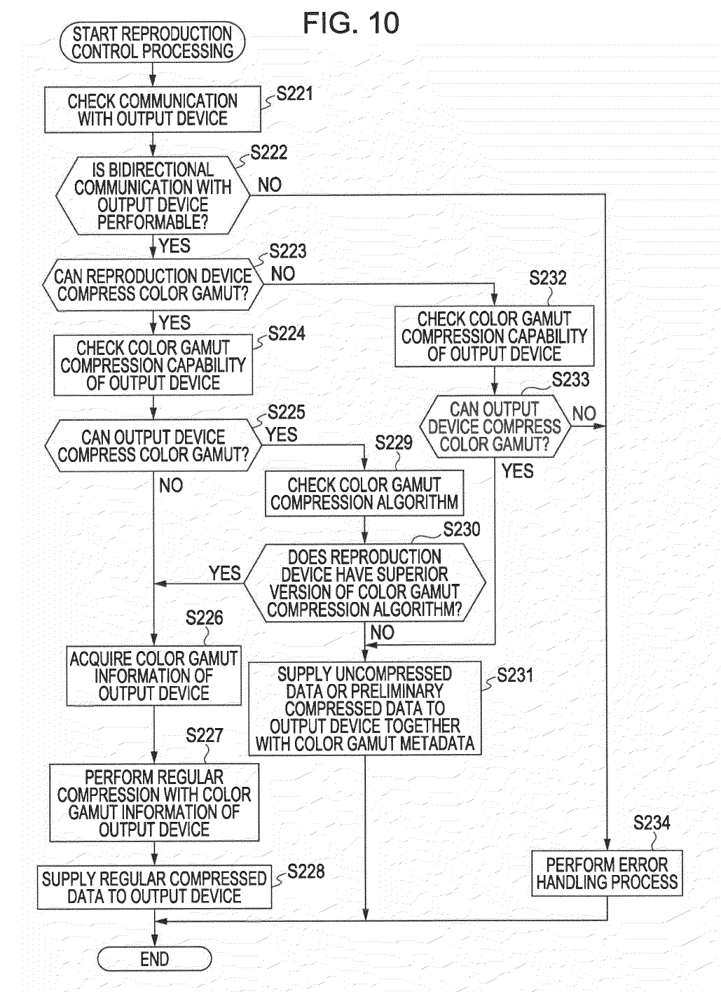

In the above description, if the reproduction device 102 and the output device 103 are both capable of performing the color gamut compression, which one of the reproduction device 102 and the output device 103 should perform the color gamut compression is controlled on the basis of the respective manufacturers of the reproduction device 102 and the output device 103. However, the configuration is not limited thereto. Thus, which one of the two devices should perform the color gamut compression may be controlled on the basis of another condition. For example, as illustrated in the flowchart of FIG. 10, the control may be performed in accordance with the relationship between the respective color gamut compression algorithms of the devices. FIG. 10 is a flowchart corresponding to the flowchart of FIG. 8. Therefore, the respective processes of Steps S221 to S234 in FIG. 10 are performed basically similarly to the respective processes of Steps S161 to S174 in FIG. 8.

As illustrated in FIG. 10, the information exchange unit 212 at Step S229 checks the color gamut compression algorithm of the output device 103. Then, at Step S230, the determination unit 213 determines whether or not the version of the color gamut compression algorithm of the reproduction device 102 is superior to (newer than) the version of the color gamut compression algorithm of the output device 103. If it is determined that the version of the reproduction device 102 is superior, the determination unit 213 returns the processing to Step S226 to perform the respective processes of Steps S226 to S228 similarly to the respective processes of Steps S166 to S168 (FIG. 8). Thereby, the color gamut compression processing unit 203 is controlled to perform the regular compression of the image data in the reproduction device 102.

Meanwhile, if it is determined at Step S230 that the version of the output device 103 is superior, the determination unit 213 proceeds the processing to Step S231 to supply the uncompressed data or the preliminary compressed data to the output device 103 together with the color gamut metadata of the data, similarly as in Step S171 (FIG. 8). Thereby, the output device 103 is caused to perform the regular compression process.

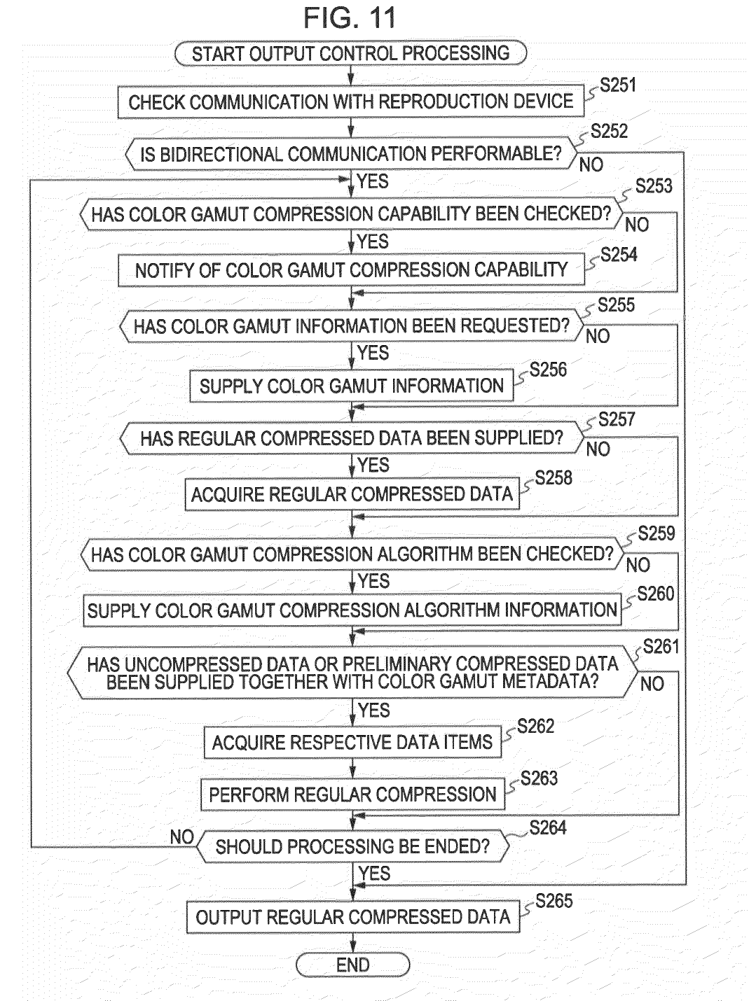

Output control processing in response to the above processing is performed as illustrated in the flowchart of FIG. 11. FIG. 11 is a flowchart corresponding to the flowchart of FIG. 9. Therefore, the respective processes of Steps S251 to S265 in FIG. 11 are performed basically similarly to the respective processes of Steps S191 to S205 in FIG. 9.

However, as illustrated in FIG. 11, the information supply unit 252 performs Steps S259 and S260 instead of Steps S199 and S200. At Step S259, the information supply unit 252 determines whether or not the color gamut compression algorithm has been checked by the reproduction device 102. If it is determined that the color gamut compression algorithm has been checked, the information supply unit 252 at Step S260 supplies, via the communication unit 251, color gamut compression algorithm information to the reproduction device 102. If it is determined at Step S259 that the color gamut compression algorithm has not been checked, the information supply unit 252 omits the process of Step S260.

As described above, the reproduction device 102 and the output device 103 can control which one thereof should perform the color gamut compression, on the basis of the color gamut compression algorithm version information thereof. Therefore, the reproduction device 102 and the output device 103 can perform more reliable and appropriate compression of the color gamut of content data, even when the content data is handled by a plurality of devices.

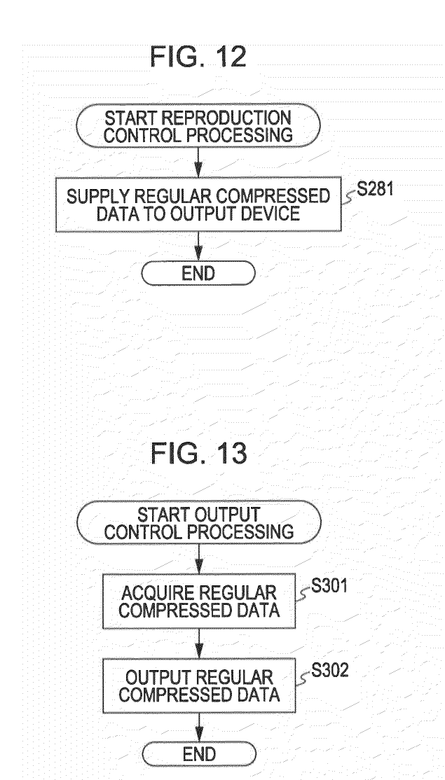

If it is determined by the determination processing of FIG. 7 that the regular compression has been performed by the recording device 101, the reproduction device 102 and the output device 103 directly exchange the regular compressed data. That is, as illustrated in the flowchart of FIG. 12, the color gamut compression control unit 202 controls the communication unit 204 to supply the regular compressed data to the output device 103. In response to this processing, the communication unit 251 of the output device 103 acquires the regular compressed data at Step S301, as illustrated in the flowchart of FIG. 13. Further, at Step S302, the output unit 254 outputs the regular compressed data.

As described above, the recording device 101, the reproduction device 102, and the output device 103 control the color gamut compression on the basis of the variety of conditions, and thus can perform more reliable and appropriate compression of the color gamut of content data.

In the above description, the reproduction device 102 takes the initiative in controlling the color gamut compression by the reproduction device 102 and the output device 103. Alternatively, the output device 103 may take the initiative in performing the control. In this case, the reproduction device 102 responds to a request from the output device 103. That is, the reproduction device 102 and the output device 103 replace each other in the configuration and the processing described above.

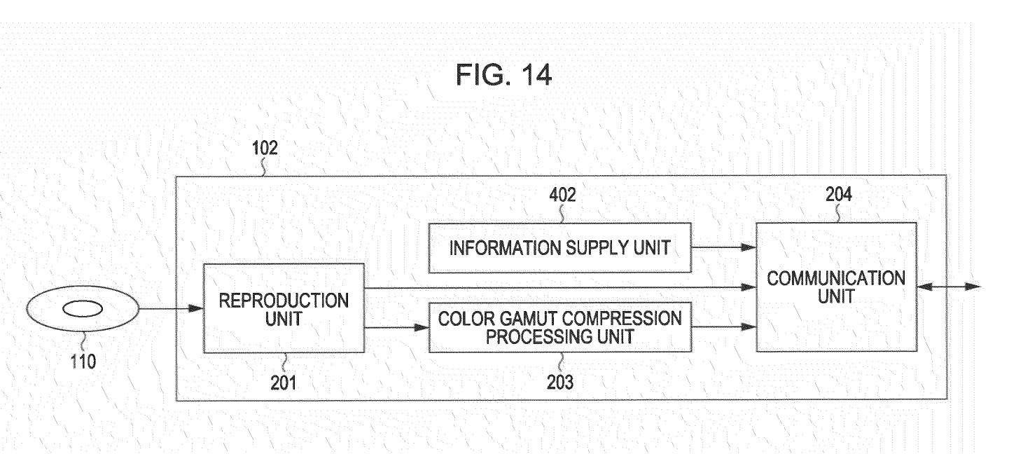

FIG. 14 is a block diagram illustrating a configuration example of the reproduction device 102 in this case. As illustrated in FIG. 14, the reproduction device 102 in this case includes an information supply unit 402 in place of the color gamut compression control unit 202. The information supply unit 402, which is similar to the information supply unit 252 in FIG. 4, supplies, via a communication unit (the communication unit 204 in this case), the information of a device including the information supply unit 402 (the reproduction device 102 in this case) to the other device (the output device 103 in this case) on the basis of a request from the other device (the output device 103 in this case).

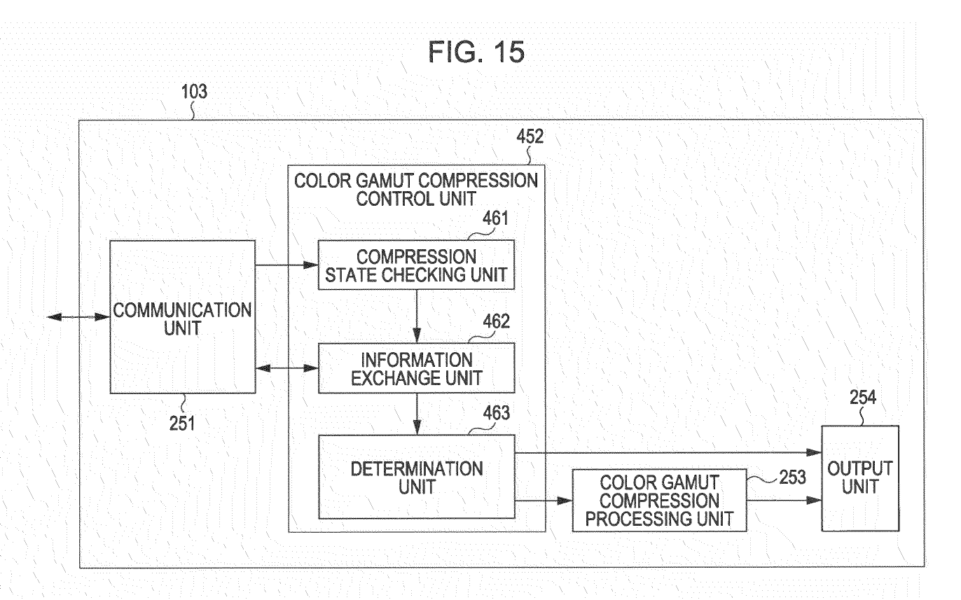

FIG. 15 is a block diagram illustrating a configuration example of the output device 103 in this case. As illustrated in FIG. 15, the output device 103 in this case includes a color gamut compression control unit 452 in place of the information supply unit 252. The color gamut compression control unit 452 performs the color gamut compression control processing similarly to the color gamut compression control unit 202 in FIG. 3. However, the color gamut compression control unit 452 performs the color gamut compression control processing from the side of the output device 103. The color gamut compression control unit 452 includes a compression state checking unit 461, an information exchange unit 462, and a determination unit 463, which correspond to the compression state checking unit 211, the information exchange unit 212, and the determination unit 213, respectively. The color gamut compression control unit 452 and the color gamut compression control unit 202 are basically similar except that the device including the color gamut compression control unit 452 is the output device 103 while the device including the color gamut compression control unit 202 is the reproduction device 102.

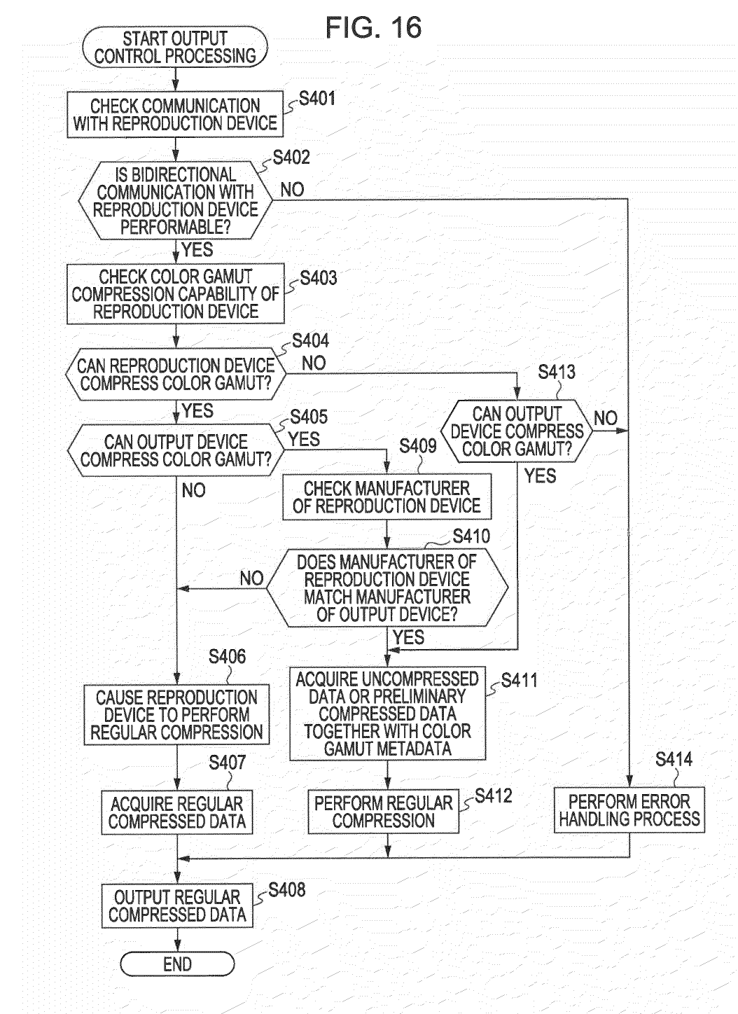

In this case, as illustrated in the flowchart of FIG. 16, output control processing performed by the output device 103 when the regular compression has not been performed by the recording device 101 is performed similarly to the reproduction control processing described with reference to the flowchart of FIG. 8. The present output control processing and the reproduction control processing of FIG. 8 are performed basically similarly except for the difference between the output device 103 and the reproduction device 102 as the device performing the control processing. That is, Steps S401 to S414 of FIG. 16 are performed similarly to Steps S161 to S174 of FIG. 8.

However, if it is determined at Step 405 that the output device 103 is not capable of performing the color gamut compression, i.e., if it is determined that only the reproduction device 102 is capable of performing the color gamut compression, the information exchange unit 462 at Step S406 supplies the color gamut information of the output device 103 to the reproduction device 102, to thereby have the reproduction device 102 perform the regular compression. Then, at Step S407, the communication unit 251 acquires the regular compressed data obtained by the regular compression, and the output unit 254 at Step S408 outputs the regular compressed data.

Further, if it is determined at Step S410 that the manufacturer of the reproduction device 102 matches the manufacturer of the output device 103, the communication unit 251 at Step S411 acquires the uncompressed data or the preliminary compressed data together with the color gamut metadata of the data. Then, at Step S412, the color gamut compression processing unit 253 performs the regular compression.

Further, if it is determined at Step S404 that the reproduction device 102 is not capable of performing the color gamut compression, the processing proceeds to Step S413, and the determination unit 463 determines whether or not the output device 103 is capable of performing the color gamut compression.

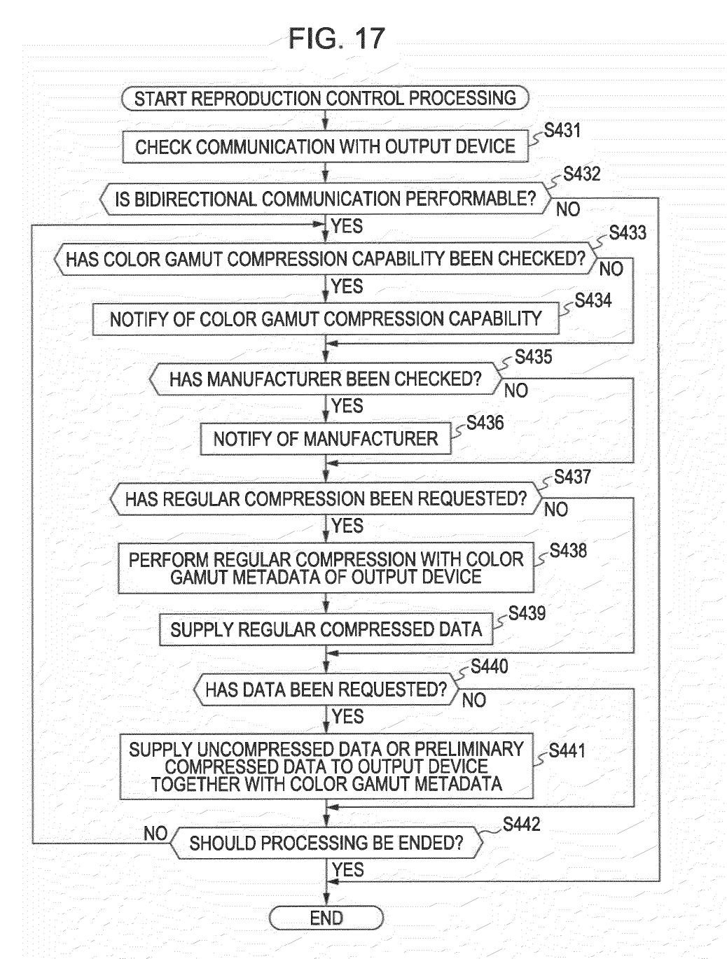

Reproduction control processing by the reproduction device 102 in response to the above processing is performed as illustrated in the flowchart of FIG. 17. This processing is performed basically in response to a request from the output device 103. The processing is performed basically similarly to the output control processing described with reference to the flowchart of FIG. 9 except that the device performing the processing is not the output device 103 but the reproduction device 102. That is, the respective processes of Steps S431 to 442 are performed similarly to the respective processes of Steps S191 to 205.

However, unlike the example of FIG. 9, the output device 103 does not use the color gamut of the reproduction device 102. Therefore, the reproduction device 102 is not requested to supply the color gamut information. Further, the reproduction device 102 does not acquire but supplies the uncompressed data or the preliminary compressed data and the color gamut metadata of the data in accordance with a request from the output device 103 (Steps S440 and S441). Further, the reproduction device 102 performs the regular compression on the basis of a request from the output device 103, and supplies the regular compressed data to the output device 103 (Steps S437 to S439).

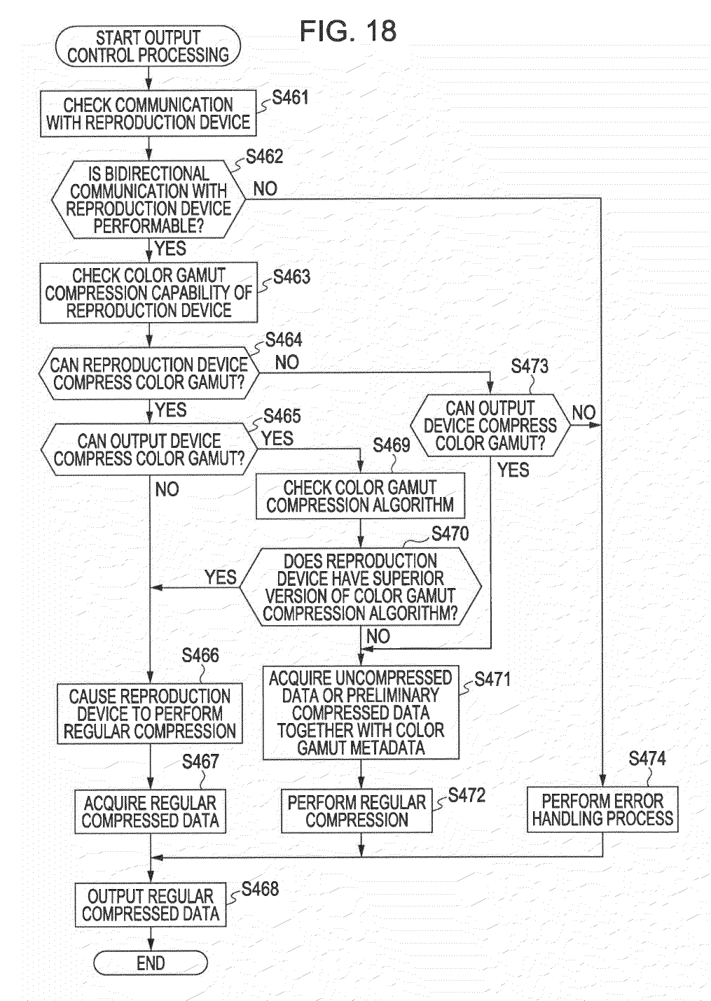

Similarly as in the example in which the reproduction device 102 takes the initiative, the color gamut compression algorithm version may, of course, be used instead of the manufacturer in the determination processing. The flow of output control processing in this case is as illustrated in the flowchart of FIG. 18. That is, except for the processes of Steps S469 and S470, the respective processes of Steps S461 to S474 are performed similarly to the respective processes of Steps S401 to S414 in FIG. 16. Further, Steps S469 and S470 are performed basically similarly to Steps S229 and S230 in FIG. 10 except for the difference in the device performing the processing, and thus description thereof will be omitted.

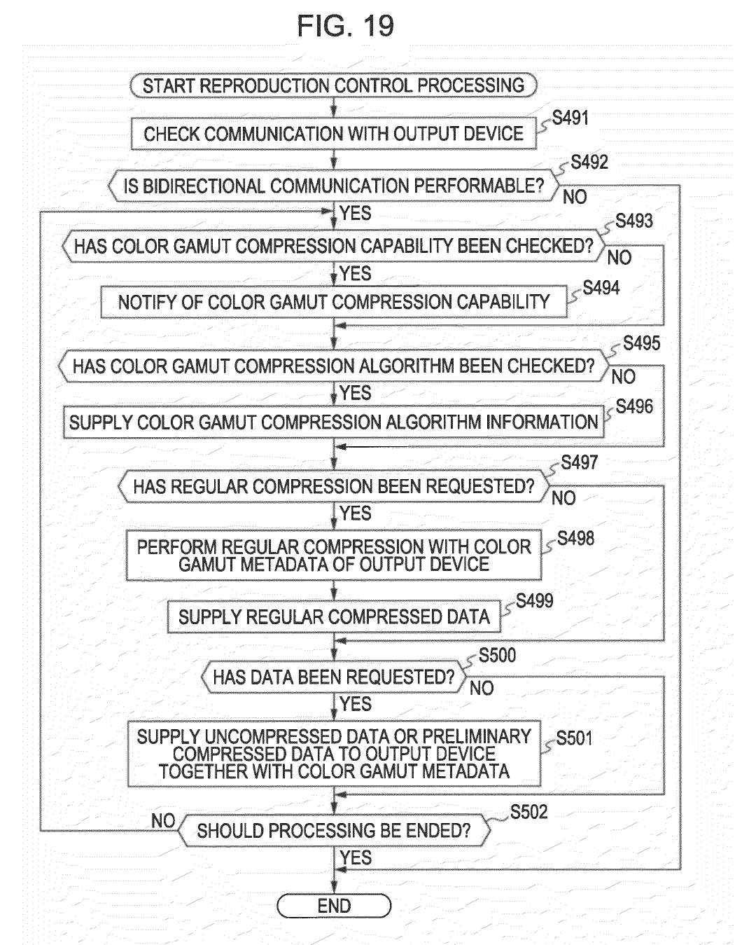

FIG. 19 is a flowchart for explaining an example of the flow of reproduction control processing in response to the output control processing of FIG. 18. As illustrated in FIG. 19, the reproduction control processing in this case is performed basically similarly to the example of FIG. 17. That is, the respective processes of Steps S491 to S502 in FIG. 19 are performed similarly to the respective processes of Steps S431 to S442 in FIG. 17. In the example of FIG. 19, however, the respective processes of Steps S495 and S496 are performed instead of the respective processes of Steps S435 and S436 in FIG. 17. The processes of Steps S495 and S496 are basically similar to the processes of Steps S259 and S260 in FIG. 11, and thus description thereof will be omitted.

As described above, also when the output device 103 takes the initiative in performing the control of the color gamut compression by the reproduction device 102 and the output device 103, the recording device 101, the reproduction device 102, and the output device 103 control the color gamut compression on the basis of the variety of conditions, and thus can perform more reliable and appropriate compression of the color gamut of content data.

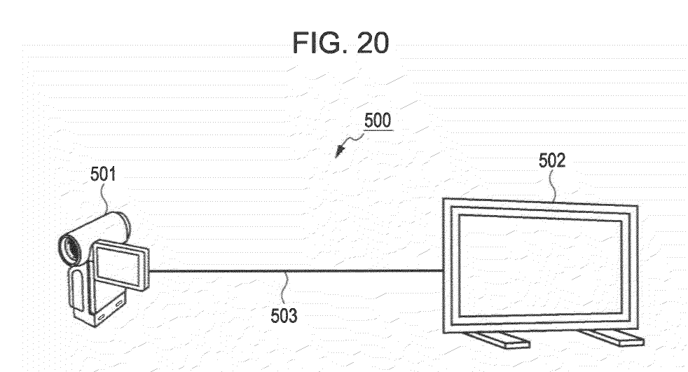

Subsequently, a more specific example of the system will be described. In recording on a tape, an information processing system 500 illustrated in FIG. 20 compresses the color gamut of a moving image captured by a video camera 501 into digital cinema color space according to the DCI (Digital Cinema Initiatives) specification. Thereafter, the video camera 501 is connected to a TV (Television) 502 by an HDMI (High-Definition Multimedia Interface) 503 to obtain the color gamut information of the TV 502. In a reproduction process, the video camera 501 displays the moving image with the color gamut compressed into the color gamut of the TV 502.

In this embodiment, the video camera 501 corresponds to a device 130 having the functions of both the recording device 101 and the reproduction device 102 illustrated in FIG. 1. The TV 502 corresponds to the output device 103. The connection state is assumed to be such that the video camera 501 and the TV 502 are connected by the HDMI 503, as illustrated in FIG. 20.

It is now assumed that the moving image captured by the video camera 501 is recorded in luminance and color-difference signal space called xvYCC color space. The xvYCC is color space for the recording of a moving image, which was established by the IEC (International Electrotechnical Commission) in 2006 and defined as an international standard IEC 61966-2-4 Ed. 1.0. The xvYCC enables the recording of 95% or more of colors perceivable by humans, and has a sufficient color gamut for the recording of colors detectable by a consumer video camera. In the present embodiment, the recorded picture content data corresponds to the moving image, and the recording device color gamut information corresponds to the xvYCC.

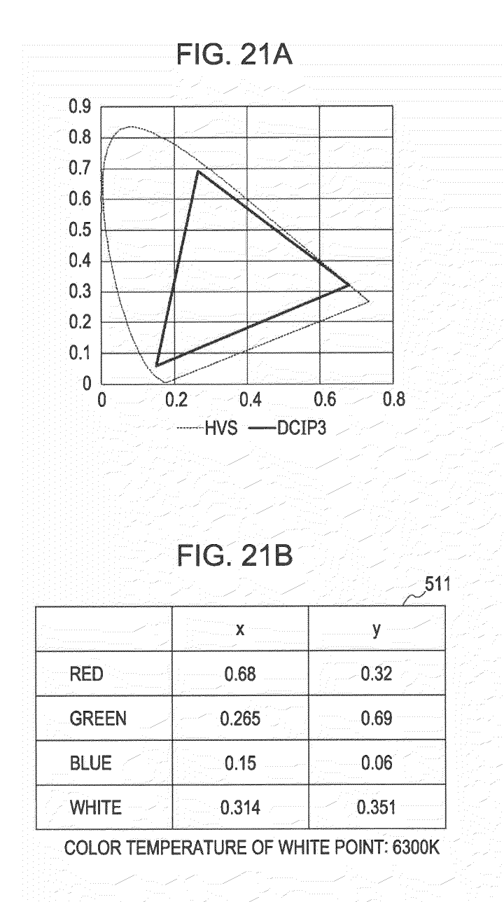

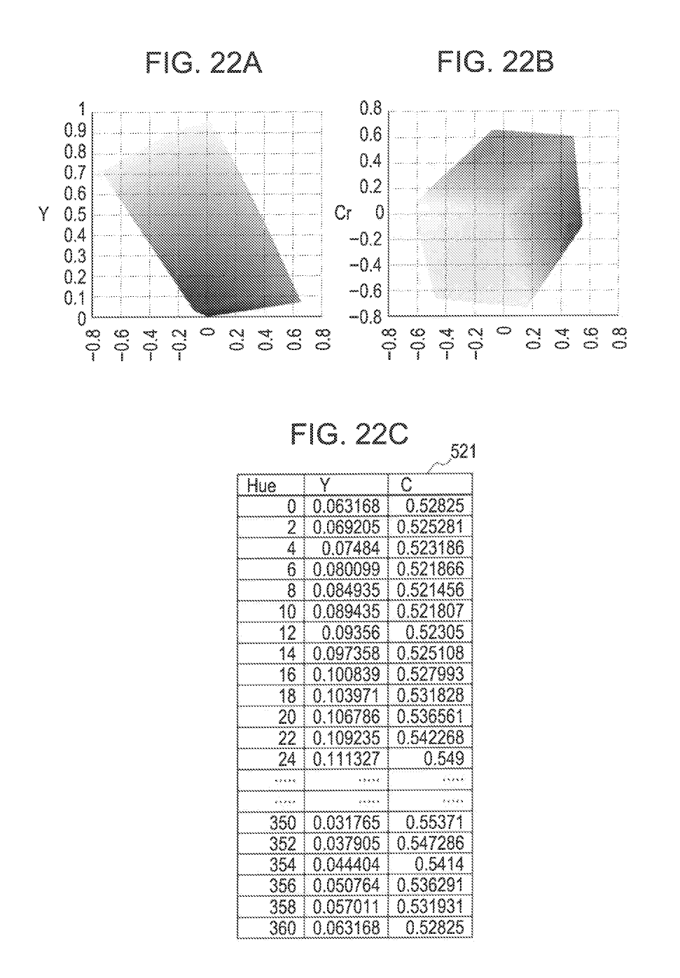

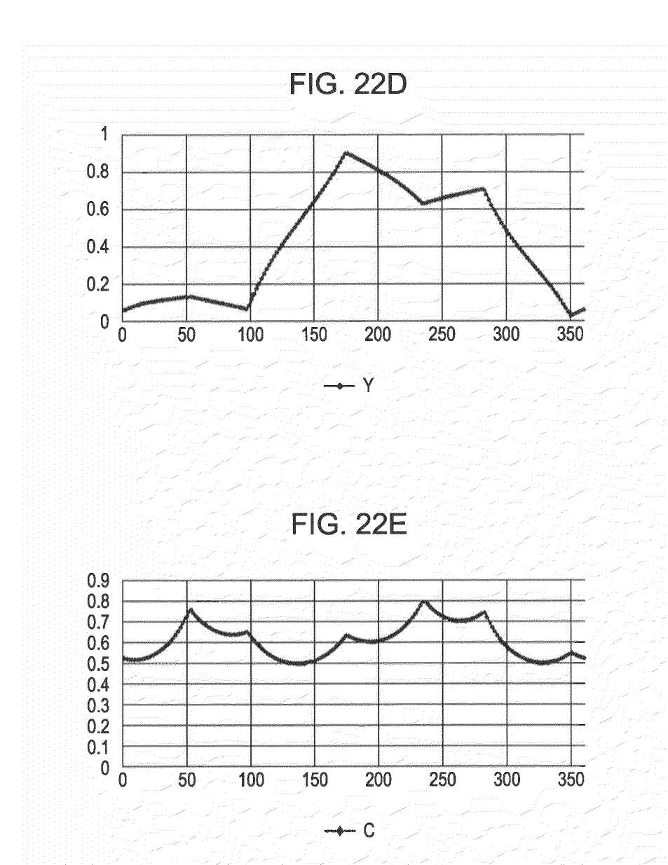

In the recording on a tape, the first color gamut compression process is performed. A preliminary output device color gamut in this compression corresponds to the color gamut of the digital cinema color space according to the DCI specification (DCI-P3). The chromaticity information of DCI-P3 is as shown in a graph of FIG. 21A and Table 511 of FIG. 21B. DCI is a consolidated company founded by seven major motion picture studios in Hollywood in March 2002 to determine digital cinema specifications, and is an organization determining industry-standard formats for supplying picture content data for digital cinema. Digital Cinema System Specification Ver. 1.1 (Apr. 12, 2007) published by DCI defines DCDM (Digital Cinema Distribution Master), which is a format for saving digital cinema picture content data. The DCDM, which is also called DTIM (Digital Theater Interim Master), was originally defined by SMPTE (Society of Motion Picture and Television Engineers) in US. DCI adopts the color gamut of the DCDM as the color gamut of a reference projector. The color gamut of DCI-P3 expressed in the xvYCC space can be represented by the values of Cusp table 521 in FIG. 22C. With the use of this Cusp table as the preliminary output device color gamut information, the color gamut of the moving image is compressed into the digital cinema color space in accordance with a predetermined color gamut compression method. A picture signal representing the compression result is recorded in the DCDM format. The color space of the DCDM format can be defined as DCI-P3. Therefore, the present picture content data is practically attached with DCI-P3 color gamut metadata. The preliminary output picture content data representing the compression result is recorded on the tape in the DCDM format.

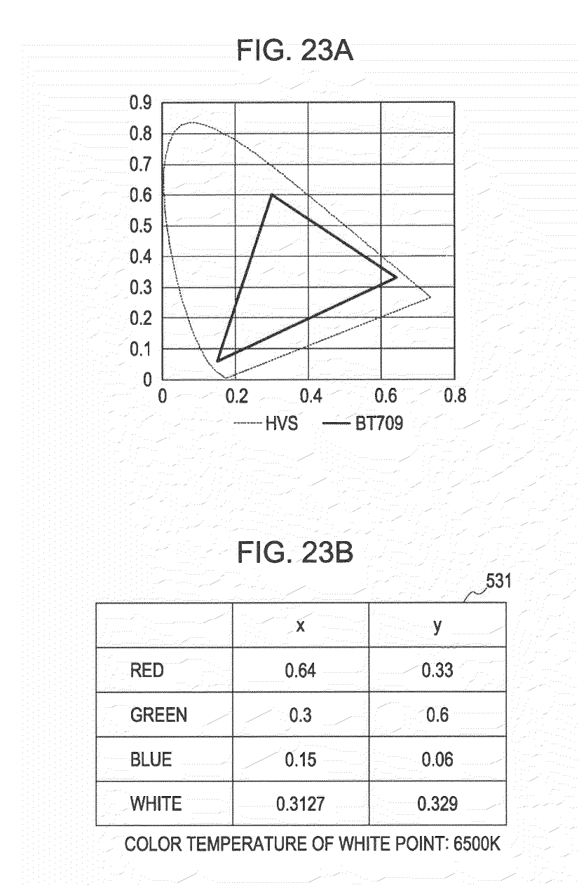

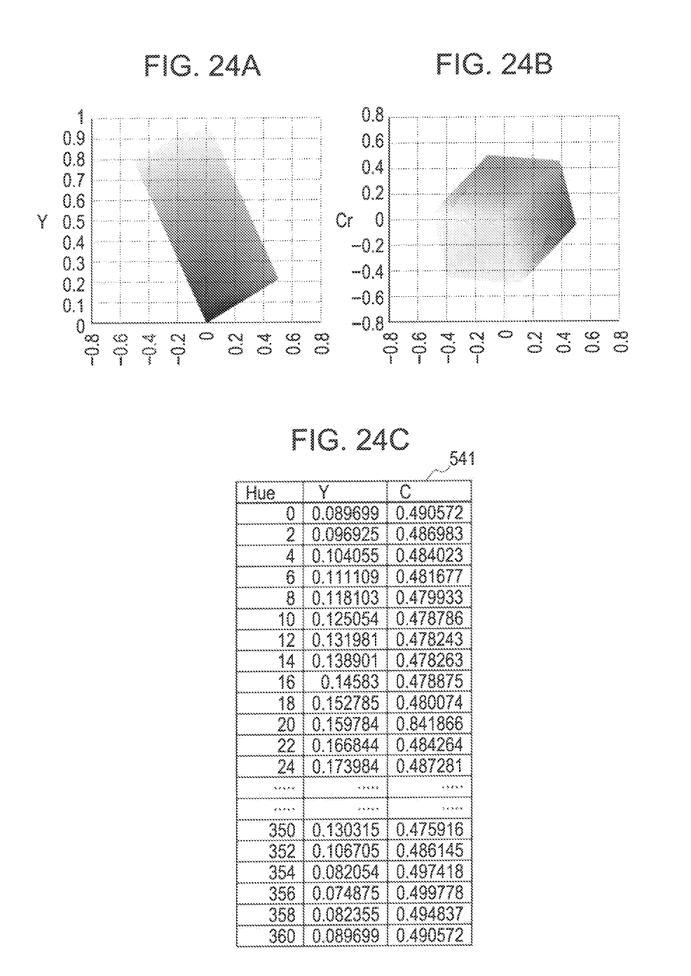

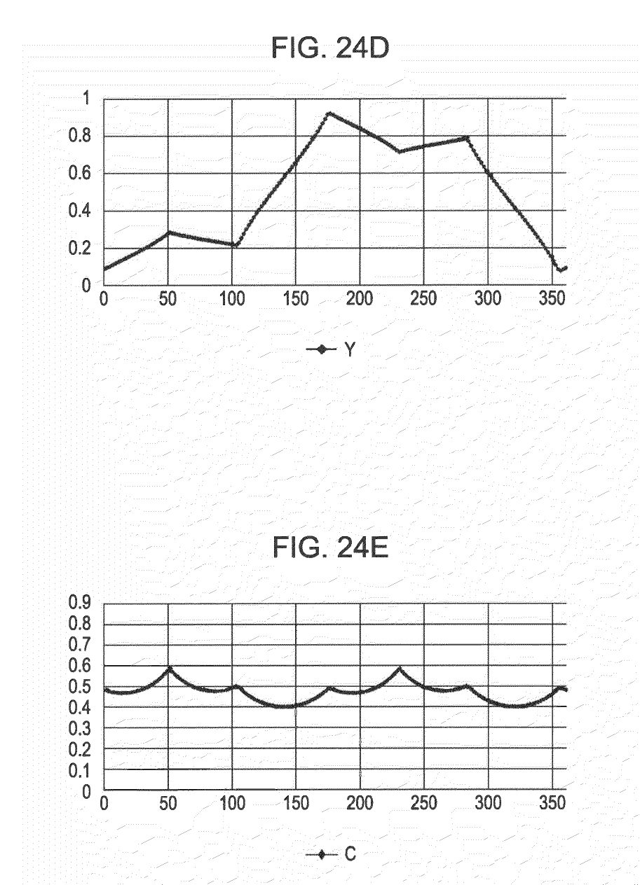

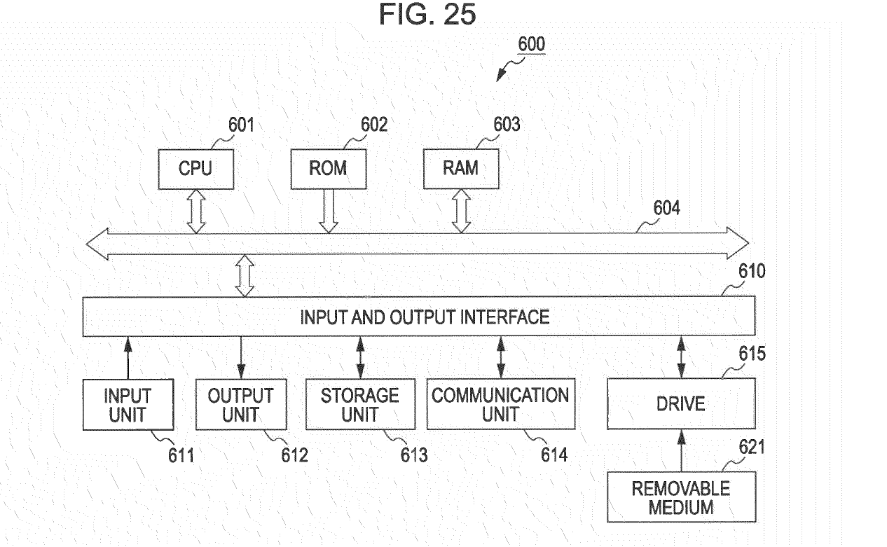

In the reproduction of the preliminary output picture content data recorded on the tape, the video camera 501 first acquires the color gamut information of the TV 502 via the HDMI 503. In this case, in the negotiation at the time of connection, connection information using EDID (Extended Display Identification Data) is exchanged. If the information of a color gamut B, which is the color gamut information of the TV 502, is written in the EDID in this process, the video camera 501 can acquire the color gamut information of the TV 502 at the time of connection to the TV 502. It is now assumed that the color gamut of the TV 502 is B709. The chromaticity information of B709 is as shown in Table 531 of FIG. 23B. With the use of the Cusp table, therefore, the color gamut of the TV 502 can be represented by Table 541 of FIG. 24C. The data of hues at two-degree intervals shown in FIG. 24C is written in the EDID as the output device color gamut metadata, and is transmitted to the video camera 501 via the HDMI 503. Then, the second color gamut compression process is performed in the reproduction process. The compression is performed in accordance with a predetermined color gamut compression method and with the use of the color gamut of DCI-P3 shown in FIGS. 22A to 22E as the preliminary output device color gamut and the color gamut of the TV 502 shown in FIGS. 24A to 24E as the output device color gamut. The final output picture content data having the TV color gamut and representing the compression result is transmitted to the TV 502 via the HDMI 503. The TV 502 displays thereon the transmitted final output picture content data.

The series of processing described above can be performed both by hardware and software. In this case, the series of processing may be configured as a personal computer illustrated in FIG. 25, for example.

In FIG. 25, a CPU (Central Processing Unit) 601 of a personal computer 600 performs a variety of processing in accordance with programs stored in a ROM (Read-Only Memory) 602 or loaded from a storage unit 613 onto a RAM (Random Access Memory) 603. The RAM 603 also stores, as appropriate, data used in the variety of processing performed by the CPU 601.

The CPU 601, the ROM 602, and the RAM 603 are mutually connected via a bus 604. The bus 604 is also connected to an input and output interface 610.

The input and output interface 610 is connected to an input unit 611 formed by a keyboard, a mouse, and so forth, an output unit 612 formed by a speaker, a display including a CRT (Cathode Ray Tube) display and an LCD (Liquid Crystal Display), and so forth, a storage unit 613 formed by a hard disk, and so forth, and a communication unit 614 formed by a modem, and so forth. The communication unit 614 performs communication processing via a network including the Internet.

The input and output interface 610 is further connected, as appropriate, to a drive 615, into which a removable medium 621 such as a magnetic disk, an optical disk, a magneto-optical disk, and a semiconductor memory is inserted as appropriate. A computer program read from the removable medium 621 is installed, as appropriate, in the storage unit 613.

To have the above-described series of processing performed by software, a program forming the software is installed from a network or a recording medium.

As illustrated in FIG. 25, for example, the configuration of the recording medium is not limited to the removable medium 621, such as a magnetic disk (including a flexible disk), an optical disk (including a CD-ROM or Compact Disc-Read Only Memory and a DVD or Digital Versatile Disc), a magneto-optical disk (including an MD or Mini Disc), and a semiconductor memory, which includes the program recorded thereon and is distributed to users separately from the device to deliver the program. The configuration of the recording medium also includes, for example, the ROM 602 or the hard disk included in the storage unit 613, which includes the program recorded thereon and thus previously installed in the device to be distributed to users.

In the present specification, the steps describing the program recorded on the recording medium include not only processes performed chronologically in the described order but also processes not necessarily performed chronologically but performed concurrently or individually.

In the above description, the configuration described as one device may be divided and configured as a plurality of devices. Conversely, the configurations described above as a plurality of devices may be integrated and configured as one device. Further, the configuration of each of the devices may, of course, be added with a configuration other than the configurations described above. Further, a part of the configuration of one of the devices may be included in the configuration of another one of the devices, if the configuration and operation of the system as a whole is substantially unchanged. That is, the embodiments of the present invention are not limited to the embodiments described above, and thus the present invention can be modified in a variety of ways within the scope not departing from the gist of the present invention.

The present application contains subject matter related to that disclosed in Japanese Priority Patent Application JP 2008-169153 filed in the Japan Patent Office on Jun. 27, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A recording device comprising:
color gamut conversion control means for controlling a method of converting the color gamut of content data, on the basis of a user-specified condition specified by a user;
color gamut conversion means for converting the color gamut of the content data in accordance with the control of the color gamut conversion control means; and
recording means for recording, on a recording medium, the content data, the color gamut of which has been converted by the color gamut conversion means in accordance with the control of the color gamut conversion control means, or the content data, the color gamut of which has not been converted by the color gamut conversion means in accordance with the control of the color gamut conversion control means.

2. The recording device according to claim 1,
wherein the color gamut conversion control means performs the control such that the color gamut of the content data is converted into a color gamut specified by the user.

3. The recording device according to claim 1,
wherein the color gamut conversion control means performs the control such that the color gamut of the content data is converted into a color gamut corresponding to a file format specified by the user.

4. A recording control method comprising the steps of:
determining a method of converting the color gamut of content data, on the basis of a user-specified condition specified by a user;
converting the color gamut of the content data in accordance with the determined method of converting the color gamut; and
controlling the recording, on a recording medium, of the content data, the color gamut of which has been converted, or the content data, the color gamut of which has not been converted.

5. A program for causing a computer to perform a recording control method, the recording control method comprising the steps of:
determining a method of converting the color gamut of content data, on the basis of a user-specified condition specified by a user;
converting the color gamut of the content data in accordance with the determined method of converting the color gamut; and
controlling the recording, on a recording medium, of the content data, the color gamut of which has been converted, or the content data, the color gamut of which has not been converted.

6. A reproduction device comprising:
reading means for reading content data recorded on a recording medium;
conversion state checking means for checking the conversion state of the color gamut of the content data read by the reading means;
color gamut conversion control means for, if it is confirmed by the conversion state checking means that the color gamut of the content data has not been converted into the color gamut of an output device at a subsequent stage, controlling a method of converting the color gamut of the content data, on the basis of information relating to the output device; and
color gamut conversion means for converting the color gamut of the content data in accordance with the control of the color gamut conversion control means.

7. The reproduction device according to claim 6,
wherein the color gamut conversion control means controls the method of converting the color gamut of the content data, in accordance with whether or not the manufacturer of the output device matches the manufacturer of the reproduction device.

8. The reproduction device according to claim 6,
wherein the color gamut conversion control means controls the method of converting the color gamut of the content data, in accordance with whether or not a color gamut conversion algorithm version of the output device is superior to a color gamut conversion algorithm version of the reproduction device.

9. A reproduction control method comprising the steps of:
controlling the reading of content data recorded on a recording medium;
checking the conversion state of the color gamut of the read content data;
determining, if it is confirmed that the color gamut of the content data has not been converted into the color gamut of an output device at a subsequent stage, a method of converting the color gamut of the content data, on the basis of information relating to the output device; and
converting the color gamut of the content data in accordance with the determined method of converting the color gamut.

10. A program for causing a computer to perform a reproduction control method, the reproduction control method comprising the steps of:
controlling the reading of content data recorded on a recording medium;
checking the conversion state of the color gamut of the read content data;
determining, if it is confirmed that the color gamut of the content data has not been converted into the color gamut of an output device at a subsequent stage, a method of converting the color gamut of the content data, on the basis of information relating to the output device; and
converting the color gamut of the content data in accordance with the determined method of converting the color gamut.

11. An output device comprising:
conversion state checking means for checking the conversion state of the color gamut of content data;
color gamut conversion control means for, if it is confirmed by the conversion state checking means that the color gamut of the content data has not been converted into the color gamut of the output device, controlling a method of converting the color gamut of the content data, on the basis of information relating to a reproduction device at a previous stage;
color gamut conversion means for converting the color gamut of the content data into the color gamut of the output device in accordance with the control of the color gamut conversion control means; and
output means for outputting the content data having the color gamut of the output device.

12. An output control method comprising the steps of:
checking the conversion state of the color gamut of content data;
determining, if it is confirmed that the color gamut of the content data has not been converted into the color gamut of an output device, a method of converting the color gamut of the content data, on the basis of information relating to a reproduction device at a previous stage;
converting the color gamut of the content data into the color gamut of the output device in accordance with the determined method of converting the color gamut; and
controlling the output of the content data having the color gamut of the output device.

13. A program for causing a computer to perform an output control method, the output control method comprising the steps of:
checking the conversion state of the color gamut of content data;
determining, if it is confirmed that the color gamut of the content data has not been converted into the color gamut of an output device, a method of converting the color gamut of the content data, on the basis of information relating to a reproduction device at a previous stage;
converting the color gamut of the content data into the color gamut of the output device in accordance with the determined method of converting the color gamut; and
controlling the output of the content data having the color gamut of the output device.

14. A recording device comprising:
a color gamut conversion control unit configured to control a method of converting the color gamut of content data, on the basis of a user-specified condition specified by a user;
a color gamut conversion unit configured to convert the color gamut of the content data in accordance with the control of the color gamut conversion control unit; and
a recording unit configured to record, on a recording medium, the content data, the color gamut of which has been converted by the color gamut conversion unit in accordance with the control of the color gamut conversion control unit, or the content data, the color gamut of which has not been converted by the color gamut conversion unit in accordance with the control of the color gamut conversion control unit.

15. A reproduction device comprising:
a reading unit configured to read content data recorded on a recording medium;
a conversion state checking unit configured to check the conversion state of the color gamut of the content data read by the reading unit;
a color gamut conversion control unit configured to, if it is confirmed by the conversion state checking unit that the color gamut of the content data has not been converted into the color gamut of an output device at a subsequent stage, control a method of converting the color gamut of the content data, on the basis of information relating to the output device; and
a color gamut conversion unit configured to convert the color gamut of the content data in accordance with the control of the color gamut conversion control unit.

16. An output device comprising:
a conversion state checking unit configured to check the conversion state of the color gamut of content data;
a color gamut conversion control unit configured to, if it is confirmed by the conversion state checking unit that the color gamut of the content data has not been converted into the color gamut of the output device, control a method of converting the color gamut of the content data, on the basis of information relating to a reproduction device at a previous stage;
a color conversion unit configured to convert the color gamut of the content data into the color gamut of the output device in accordance with the control of the color gamut conversion control unit; and
an output unit configured to output the content data having the color gamut of the output device.
